(19) United States
(12) Patent Application Publication
(10) Pub. No.: US 2008/0096713 A1
(43) Pub. Date: Apr. 24, 2008

(54) Overdrive and underdrive power converting modulators, and methods

(76) Inventor: Thomas W. Beson, Menasha, WI (US)

Correspondence Address: WILHELM LAW SERVICE, S.C., 100 W LAWRENCE ST, THIRD FLOOR, APPLETON, WI, 54911, US

(21) Appl. No.: 11/973,911

(22) Filed: Oct. 10, 2007

Related U.S. Application Data
(60) Provisional application No. 60/828,904, filed on Oct. 10, 2006.

(51) Int. Cl. F16H 35/02; F16H 3/44; F16H 48/06; G06F 19/00

(52) U.S. Cl. 475/16; 475/269; 475/149; 701/51

(57) ABSTRACT

Power converting modulators used with internal combustion engines in driving loads. Such modulator includes an overdrive and/or underdrive mechanism based on a planetary gear assembly. The planetary gear assembly is modulated such that the overdrive or underdrive ratio varies continuously and smoothly with respect to speed of the engine, and approaches 1/1 at high engine speeds. Where the load is an alternator, the alternator is overdriven at relatively low engine speed, and provides generally constant rated power output of the alternator at all engine speeds. Where the load is a mechanical drive train, the load is modulated and thereby underdriven during engine acceleration, resulting in relatively faster engine speed acceleration, followed by demodulating the load, thereby smoothly applying full potential load to the engine while maintaining the higher engine speed.

### BACKGROUND

This invention relates generally to overdrive and underdrive power-converting modulator devices which are used with e.g. internal combustion engines to modulate the output shaft energy of such internal combustion engines so as to enhance the utility of such output energy. In particular, the present invention is an improved drive mechanism which utilizes a planetary gear set-based drive pulley, unique methods of modulating the planetary gear set, and corresponding methods of modulating the power output from an internal combustion engine using such planetary gear set.

Alternators are frequently used in combination with internal combustion engines to produce electrical energy/power. A common use of an alternator is to generate electrical energy in any of a variety of mobile motor vehicles. In a typical internal combustion engine vehicle, the engine crankshaft drives a drive belt which in turn drives a pulley which in turn drives an alternator. The electrical energy produced by the alternator powers the various electrical system(s) and components in the vehicle.

Over time, the number of electrically powered accessories and components in vehicle electrical systems has increased. Also, certain ones of such electrical accessories and components now require relatively more electrical power to operate, as compared to earlier versions of such items. In other words, the electrical power demands of modern vehicles are relatively greater than the electrical power demands of earlier vehicles. This trend seems to be continuously increasing over time whereupon the demand for a dependable supply of electrical power on board the vehicle is correspondingly increasing.

Increased electrical demands of modern vehicles can, on occasion, lead to various troubles, annoyances, problems, and/or failures. Some such troubles are more readily apparent during relatively low-engine speed operating conditions, such as at or near engine idle conditions.

As one example, some cars, trucks, and/or other passenger or freight vehicles have relatively sophisticated and/or elaborate audio systems. These audio systems can require substantial amounts of electrical power to operate. At times, the users of such audio systems desire to enjoy such systems while traveling at low vehicle speeds or while the vehicle is stationary, i.e. at low engine speed (low RPM).

However, during such periods of low engine speed, the alternator output can be insufficient to satisfy the vehicle electrical power demands. Namely, the alternator input shaft rotates at a speed which corresponds directly and linearly to the rotational velocity of the engine crankshaft; whereby relatively low engine speed corresponds to relatively low alternator rotor rotational velocity and thus relatively low alternator electric power output.

During usage, if the alternator electric power output is sufficiently low and the vehicle electrical power consumption is sufficiently high, then the vehicle electrical system will draw from the battery at a greater rate than the rate at which the alternator can recharge the battery. In other words, in such situations, the vehicle's electrical accessories drain the battery, even though the engine is running and the alternator is producing some electrical power. Drained batteries can, for example, lack sufficient power to restart the engine if the engine turns off, thus stranding the user with an inoperable vehicle.

As another example, boats and/or other recreational vehicles can also have relatively sophisticated and/or elaborate audio systems. In addition, boats can have numerous other auxiliary electrical loads, including, for example, lights, navigation devices such as GPS and RADAR devices, depth sounders and other depth finders, fish locators, communication devices such as VHF marine band transceivers, bilge and other pumps, exhaust fans, and/or others.

The problem of insufficient delivery of electrical power is most acute where the boat engine is operated at idle speed or low speed for extended periods of time. Such extended times can occur e.g. while fishing at trolling speed, or while traveling a substantial distance between dockage and open water, or while milling around at idle waiting for the start of a fishing tournament, similarly while milling around at idle waiting for the fisherman's tow trailer's turn at the launch ramp, or while traveling through congested or otherwise dangerous waters.

Referring to fishing boats in particular, many such boats include various ones of the aforementioned electrically-powered devices and also one or more electric trolling motors. Many electric trolling motors are relatively high-Amp using devices and thus can draw down batteries rather quickly. Often, a user of an electric trolling motor carries additional batteries to power the trolling motor.

However, even the one or more auxiliary battery, dedicated for trolling motor or other ancillary load use, can require recharging during extended use. Accordingly, some users, on occasion, start and run the boat's engine for no purpose other than to recharge the batteries by way of the alternator.

Unfortunately, recharging the batteries at idle or low engine speed can take longer than at relatively higher engine speeds because the alternators typically used in such vehicles require moderate-to-high engine speeds in order to produce maximum or near maximum recharge power output.

It is often not desirable to operate a marine engine at relatively higher engine speeds while the boat's transmission is in neutral. Accordingly, a user may drive the boat about, until the batteries are sufficiently recharged. If the user wishes to remain fishing, or perhaps leisurely sitting, anchored, docked or floating, such a battery recharge excursion can prove frustrating and/or annoying.

Low operational speed alternator output problems are not unique to the marine vehicle industry. As another example, many portable internal combustion engine powered generators have discrete operating speeds. For instance, some portable generators have a default engine speed of approximately engine idle or low engine speed. Then, when a load is applied, such as when a significant current is drawn from the generator device, i.e. when a device is plugged into or otherwise connected to the generator for use, the internal combustion engine of the generator increases its speed, typically dramatically, to produce the required amount of current at the appropriate frequency.

However, increasing the engine speed increases fuel consumption, exhaust and other emission output, as well as operating sound volume of the engine.

To deal with the need for a more continuous supply of electrical power, generally one or more of two approaches is used. The first approach is to simply carry more batteries in the vehicle. Carrying more batteries can provide more use time between battery recharge requirements. However, batteries are heavy and fairly large devices, whereby carrying many batteries in a boat (or other vehicle) adds substantial weight to the vehicle. There can, in addition, be difficulty in finding space in which to stow the additional batteries, as space commonly identified in boat design, as being available for battery stowage, and other motor vehicles, is typically quite small. In addition, common lead acid storage batteries are very heavy and accelerating and maintaining their speed over the water consumes considerable fuel.

The second approach to achieving a more continuous power supply deals with the alternator, itself. As one example, a user can install a larger, relatively higher output, alternator to achieve relatively higher alternator power output levels. However, in vehicle engine compartments, space is typically at a premium as well, whereby a larger sized alternator may not be a cost-effective option. Particularly, in boat outboard engine applications, the alternator is located under the engine cover, and the space under the engine cover is so limited that installing a larger, relatively higher output, alternator may be impossible or impractical, without modifying the engine cover. In addition to space constraints, vehicle designers and engineers frequently strive to reduce overall vehicle weight, whereupon larger alternators, which weigh relatively more than relatively smaller alternators contravene such efforts. For these and other reasons, it is desirable to use the smallest alternators possible in outboard engine applications, where the alternator maximum power output is generally matched to the overall electrical needs, including battery recharge needs, of the vehicle, rather than using an “atypically large” alternator for the respective vehicle.

As another example, a user can install different sized pulleys to change the operating characteristics of an alternator. Rotational velocities of alternator rotors, thus power output of alternators, are determined by the diameter of the alternator drive pulley. At a given drive belt velocity, a relatively greater diameter drive pulley defines a relatively slower rotating alternator rotor, whilst a relatively lesser diameter drive pulley defines a relatively faster rotating alternator rotor and more power output.

However, when trying to gain alternator rotational velocity by using relatively smaller diameter drive pulleys, a law of diminishing returns applies. For example, at some point, when decreasing the magnitude of the pulley diameter, the drive pulley diameter becomes too small, whereby there is not enough contact surface area between the drive belt and the pulley outer circumferential surface, whereupon the belt slips on the pulley during use. Even when belt slippage is not a problem, at a relatively higher engine speed, when the drive pulley diameter is too small, the rotational velocity of the alternator rotor is correspondingly excessive, which can create excessive heat and/or other excessive speed related problems, e.g. centrifugal force explosions, in the alternator.

Attempts have been made to provide multi speed output alternator drive pulleys which define multiple paths of torque transmission through the devices and thus require e.g. one-way clutches or bearings and/or overrunning clutches or bearings. Such devices can be less effective than desirable because the transition between the e.g. one-way clutch torque transmission path and the non-one-way clutch torque transmission path can define shock loads and/or other stresses in such multiple speed devices.

It is thus desirable to provide an alternator having a continuously variable overdriving pulley, wherein the pulley overdrives the alternator by an overdrive ratio which is continuously modulated according to changes in engine speed, so as to change the overdrive ratio inversely to changes in engine speed, and approaching and/or achieving a 1/1 e.g. lock-up ratio of alternator angular rotor speed to angular pulley speed at maximum loaded engine speed. Additionally, with modulation, at no time does the alternator rotor have to change direction.

It is also desirable to provide an alternator having a continuously variable overdriving pulley, wherein the pulley defines a single path of torque transmission therethrough to the alternator, while continuously modulating pulley angular output speed relative to pulley angular input speed.

It is also desirable to provide an alternator having a continuously variable overdriving pulley, wherein the pulley defines a single path of torque transmission therethrough and wherein the pulley angular output speed and thus alternator angular rotor speed is controlled by e.g. modulating one or more portions of the overdriving pulley device.

It is also desirable to provide an alternator with a continuously variable overdriving pulley, wherein the pulley defines a single path of torque transmission therethrough so the pulley angular output speed and thus alternator angular rotor speed are controlled by mechanically modulating one or more portions of the overdriving pulley device.

It is also desirable to provide an alternator having a continuously variable overdriving pulley, wherein the pulley defines a single path of torque transmission therethrough and the pulley output speed and thus alternator rotor speed are controlled by electromagnetically modulating one or more portions of the overdriving pulley device.

It is also desirable to provide an alternator having a continuously variable overdriving pulley, wherein the pulley defines a single path of torque transmission therethrough and the pulley output speed and thus alternator rotor speed are controlled by mechanically and electromagnetically modulating one or more portions of the overdriving pulley device.

An additional issue with transferring power from an internal combustion engine to a driven device is that the power the engine speed, up to optimum speed, the lower the power output from the engine, as illustrated by well known charts of engine power which show horsepower output as related to engine speed.

In many land-based vehicle engine applications, it is well known to shift gears as vehicle speed increases, whether using a manual transmission or an automatic transmission. It is also known to use a continuously variable drive transmission in a land-based vehicle wherein a belt engages lesser and greater diameter portions of a drive cone as the engine speed changes, thereby “continuously shifting” the drive ratio in accord with a combination of engine speed and applied load. The effort here is to frequently change the engagement surfaces of the transmission elements such that the transmission elements which are engaged at any given time match the desired drive ratio between the engine speed and the driven load.

By contrast, in mechanical drive trains for watercraft and aircraft, no cost-effective such transmissions are known which have the capability to shift the ratio of engine output shaft speed relative to the mechanical load shaft speed, thus resulting in a constant ratio of engine speed to load speed. A constant ratio of engine speed to load speed presents a problem which is particularly acute in watercraft where the load of moving the watercraft through the water begins as soon as the propeller drive shaft is engaged to the engine. In practice, such engagement routinely occurs at low engine speed.

Historically, outboard engines were 2-cycle engines because 2-cycle engines have a relatively higher output of power, relative to rated maximum power, at low engine speeds, compared to 4-cycle engines. But 2-cycle engines have historically produced more pollutants than 4-cycle engines. So the industry has begun moving away from 2-cycle outboard engines and toward 4-cycle outboard engines. However, such movement is encountering the obstacle of customer resistance because of the relatively lower power/torque output of 4-cycle engines at lower engine speed.

The basic problem is that conventional marine engines drive systems are designed for the user to shift the transmission between “neutral,” and “forward” or “reverse” drive settings only while the engine is running at a low speed such as idle speed. Only after the drive shaft to the propeller is engaged is the throttle advanced to thereby cause the engine to advance speed toward full operating power, full throttle. Thus, a substantial load is already being applied to the engine at low speed, and such load remains coupled to the engine output shaft, and increasing in magnitude, as the engine gains speed. The overall result is that the desired rapid increase in engine speed, which enables full power output, is retarded by the already-applied load.

It is thus desirable to provide a power conversion device which enables the engine to rapidly build engine speed while applying a limited load to the engine output shaft.

It is further desirable to provide a power conversion device which modulates the load such that the engine speed is maintained at or proximate a relatively constant engine speed while the load speed is increased to a maximum load operating speed.

It is yet further desirable to provide a power conversion device which modulates the load speed relative to the engine speed during rated-speed operations of the load so as to provide sufficient power to the load to be efficiently responsive to changes in the load while limiting the amount of fuel being consumed in powering the engine.

It is thus desirable to provide a continuously variable underdriving modulating assembly wherein the modulating assembly underdrives the load by an underdrive ratio which continuously modulates the load so as to provide desired acceleration to the load while maintaining relatively constant engine speed within a relatively high power-output engine speed range, and approaching and/or achieving a 1/1 lock-up-capable ratio of load angular shaft speed to angular modulating assembly input speed at maximum loaded engine speed.

It is also desirable to provide a continuously variable overdriving/underdriving modulating assembly wherein the modulating assembly defines a single path of torque transmission therethrough and wherein the modulating assembly angular output speed, and thus load drive speed, is controlled by modulating one or more portions of the overdriving/underdriving modulating assembly device.

It is further desirable to provide a continuously variable modulating assembly device wherein the output speed of the modulating assembly is controlled by mechanically modulating one or more portions of the modulating assembly device.

It is further desirable to provide a continuously variable modulating assembly device wherein the output speed of the modulating assembly is controlled by electromechanically modulating one or more portions of the modulating assembly device.

It is further desirable to provide a continuously variable modulating assembly device wherein the output speed of the modulating assembly is controlled by both mechanically and electromechanically modulating one or more portions of the modulating assembly device.

Whatever the load, whether the modulating assembly device overdrives or underdrives the load, it is desirable to provide sensors which directly or indirectly sense both the angular input speed of the modulating assembly device and the angular output speed of the modulating assembly device, to provide sensed data from the sensors to the computer, and to provide modulation commands from the computer to the modulating assembly device thus to modulate the modulating assembly device input/output ratio.

It is further desirable to have the computer modulate the input/output ratio so as to maintain engine speed at a speed which provides relatively greater engine power output.

### SUMMARY OF THE INVENTION

The invention provides a novel power converting modulator device for use with an internal combustion engine in driving a load, which includes an overdrive and/or underdrive mechanism having a planetary gear assembly. The power converting modulator device modulates the planetary gear assembly therein such that the rate at which the load is overdriven or underdriven, namely the overdrive or underdrive ratio, varies continuously with respect to the speed of the internal combustion engine. Where the load is an alternator which develops electrical power, and the alternator is overdriven at relatively lower engine speed, the alternator can provide a generally constant power output at or proximate the rated power output of the alternator, irrespective of changes in operating speed of the internal combustion engine. Where the load is e.g. a mechanical drive train which is underdriven during engine acceleration, the power conversion device provides for generally faster engine speed acceleration while underdriving the load, followed by an increase in load angular speed while engine speed is maintained relatively constant at or proximate a speed at which the engine produces a level of power generally corresponding to rated power output of such engine.

In a first family of embodiments, the invention comprehends an underdriving or overdriving power converting modulator assembly adapted and configured to be driven by an internal combustion engine. The power converting modulator assembly comprises a planetary gear assembly having an input component, an output component, and a modulated component. The planetary gear assembly comprises a ring gear, a sun gear axially aligned with said ring gear and disposed concentrically inwardly of said ring gear, a plurality of planet gears engaging both said ring gear and said sun gear, and a planet carrier confining said planet gears between said ring gear and said sun gear. The power converting modulator assembly further comprises a modulator communicating with one of the ring gear, the sun gear, and the planet carrier, and modulating an input/output ratio of the others of the ring gear, the sun gear, and the planet carrier.

In some embodiments, the power converting modulator assembly further comprises a load which is to be driven by the power converting modulator assembly, the load being drivingly connected to one of the sun gear and the planet carrier as the output component of the planetary gear assembly.

In some embodiments, the power converting modulator assembly is an overdriving modulator assembly and wherein the load comprises an alternator.

In some embodiments, the modulator is selected from the group consisting of mechanical brakes, hydraulic circuits, and electromagnetically actuated modulators.

In some embodiments, the modulator modulates one of the ring gear and the planet carrier.

In some embodiments, the input component comprises the planet carrier and the output component comprises the sun gear.

In some embodiments, the input component comprises the ring gear and the output component comprises the sun gear.

In some embodiments, the power converting modulator assembly is an underdriving assembly.

In some embodiments, the input component comprises the sun gear and the output component comprises the ring gear.

In some embodiments, the input component comprises the sun gear and the output component comprises the planet carrier.

In some embodiments, the assembly further comprises a load which is to be driven by the power converting modulator assembly, the load being drivingly connected to one of the ring gear and the planet carrier as the output component of the planetary gear assembly.

In some embodiments, the load comprises a vehicular drive train in a vehicle, and wherein the vehicular drive train is adapted and configured to move the vehicle.

In some embodiments, the modulator modulates the input/output ratio such that such input/output ratio at least approaches 1/1 as such engine approaches maximum rated speed.

In some embodiments, the assembly further comprises a computer controller controlling the modulation of the one of the ring gear, the sun gear, and the planet carrier by the modulator.

In a second family of embodiments, the invention comprehends in combination, an alternator and an alternator drive assembly, adapted to be driven by an internal combustion engine. The alternator and alternator drive assembly comprises an alternator having a stator, a rotor, and a drive shaft; and a modulated overdriving alternator drive assembly connected to the drive shaft of the alternator, the modulated overdriving alternator drive assembly comprising a planetary gear assembly having an input component, an output component, and a modulated component, the planetary gear assembly comprising a ring gear, a sun gear, a plurality of planet gears engaging both the ring gear and the sun gear, and a planet carrier confining the planet gears between the ring gear and the sun gear, and the combination further comprising a modulator communicating with, and modulating, one of the ring gear, the sun gear, and the planet carrier, and thereby modulating an output/input ratio of the others of the ring gear, the sun gear, and the planet carrier.

In some embodiments, the modulated planetary overdriving alternator drive assembly has a maximum overdriving output/input ratio of about 3/1 to about 8/1.

In some embodiments, the modulator modulates the overdriving output/input ratio such that the overdriving ratio at least approaches 1/1 as the engine approaches maximum rated speed.

In some embodiments, the drive shaft of the alternator is drivingly engaged with the sun gear.

In some embodiments, the modulator communicates with, and modulates, one of the planet carrier and the ring gear.

In some embodiments, the modulator is selected from the group consisting of mechanical brakes, hydraulic circuits, and electromagnetically actuated actuators.

In a third family of embodiments, the invention comprehends a method of driving a load using an internal combustion engine as a driving power source. The method comprises driving the load through a modulated underdrive mechanism having a minimum underdrive output speed/input speed ratio, and a maximum underdrive output speed/input speed ratio of up to about 1/1, the underdrive mechanism being driven by an output of the engine, and the load being driven by an output of the modulated underdrive mechanism. The driving of the load comprises, when operating the engine in a strong acceleration mode to a higher engine speed, modulating the underdrive mechanism so as to avoid transfer of full potential load to the engine during such strong acceleration; and after the engine has reached the higher engine speed, demodulating the underdrive mechanism at a continuously increasing drive ratio so as to smoothly apply full potential load to the engine while maintaining engine speed at or near the higher engine speed.

In some embodiments, the method further comprises operating the underdrive modulating mechanism as substantially a direct drive when the engine is not in a strong acceleration mode.

In some embodiments, the method further comprises modulating the output of the engine using a modulated underdrive mechanism which comprises a planetary gear assembly and a modulator, the planetary gear assembly having an input component, an output component, and a modulated component, and wherein the planetary gear assembly comprises a ring gear, a sun gear, a plurality of planet gears engaging both the ring gear and the sun gear, and a planet carrier confining the planet gears between the ring gear and the sun gear, and wherein the modulator modulates one of the ring gear and the planet carrier.

In some embodiments, the load comprises a vehicle drive train driving a vehicle.

In some embodiments, the modulator is selected from the group consisting of mechanical brakes, hydraulic circuits, and electromagnetically actuated modulators.

In some embodiments, the method comprises inputting drive power from the engine into the modulated underdrive mechanism at the sun gear, and transferring drive power from the modulated underdrive mechanism to the load at one of the ring gear and the planet carrier.

In some embodiments, the method further comprises sensing angular input speed into the modulator and angular output speed out of the modulator, feeding the sensed input and output speeds to a computer controller, and outputting modulation commands from the computer controller to the modulator, thereby to control the modulation of the output speed/input speed ratio.

### BRIEF DESCRIPTION OF THE DRAWINGS

FIG. 1A illustrates a pictorial view of a first embodiment of overdrive modulating assemblies of the invention.

FIG. 1B is a graph which shows exemplary alternator output characteristics of the invention, in terms of percentage of maximum alternator current output as a function of percentage maximum engine speed.

FIG. 2A illustrates a pictorial view of a second embodiment of overdrive modulating assemblies of the invention.

FIG. 2B illustrates an exploded, pictorial view of the overdrive modulating assembly of FIG. 2A.

FIG. 3A illustrates a pictorial view of a third embodiment of overdrive modulating assemblies of the invention.

FIG. 3B illustrates an exploded, pictorial view of the overdrive modulating assembly of FIG. 3A.

FIG. 4A illustrates a pictorial view of a fourth embodiment of overdrive modulating assemblies of the invention.

FIG. 4B illustrates an exploded, pictorial view of the overdrive modulating assembly of FIG. 4A.

FIG. 5A illustrates a pictorial view of a fifth embodiment of overdrive modulating assemblies of the invention.

FIG. 5B illustrates an exploded, pictorial view of the overdrive modulating assembly of FIG. 5A.

FIG. 6A illustrates a pictorial view of a sixth embodiment of overdrive modulating assemblies of the invention.

FIG. 6B illustrates an exploded, pictorial view of the overdrive modulating assembly of FIG. 6A.

FIG. 7A illustrates a pictorial view of a seventh embodiment of overdrive modulating assemblies of the invention.

FIG. 7B illustrates an exploded, pictorial view of the overdrive modulating assembly of FIG. 7A.

FIG. 8A illustrates a pictorial view of an eighth embodiment of overdrive modulating assemblies of the invention.

FIG. 8B illustrates an exploded, pictorial view of the overdrive modulating assembly of FIG. 8A.

FIG. 8C illustrates a cross sectional view of the hydraulic mechanism of FIG. 8A, taken at line 8C-8C of FIG. 8A.

FIG. 9A illustrates an exploded, pictorial view of a first embodiment of a planetary gear set used in modulating alternators and other power conversion devices of the invention.

FIG. 9B illustrates an exploded, pictorial, view of a second embodiment of a planetary gear set used in modulating alternators and other power conversion devices of the invention.

FIG. 9C illustrates an exploded, pictorial, view of a third embodiment of a planetary gear set used in modulating alternators and other power conversion devices of the invention.

FIG. 10A illustrates a cross-sectional view of the planetary gear set of FIG. 9A, without the alignment plates shown, with the planet gears in a first, freely rotating position.

FIG. 10B illustrates a cross-sectional view of the planetary gear set of FIG. 9A, without the alignment plates shown, with the planet gears in a second, braking position.

FIG. 11A illustrates a cross-sectional view of the planetary gear set of FIG. 9A, without the alignment plates shown, with the planet gears in a first, freely rotating position and with an auxiliary friction disc.

FIG. 11B illustrates a cross-sectional view of the planetary gear set of FIG. 9A, without the alignment plates shown, with the planet gears in a first, freely rotating position and with an auxiliary friction disc.

FIG. 12 illustrates, in partial block diagram format, a ninth embodiment of overdrive modulating assemblies of the invention.

FIG. 13 shows a side elevation view of a tenth embodiment of overdrive modulation assemblies of the invention.

FIG. 14 shows an end view of the modulation assembly of FIG. 14, with an end panel cut away to show the interior of the self-modulating hydraulic pump.

FIG. 15 shows a ninth embodiment, illustrating underdrive modulating assemblies of the invention wherein engine drive power is received at the sun gear, modulated by the planet carrier, and load power is taken off at the ring gear.

The invention is not limited in its application to the details of construction, or to the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

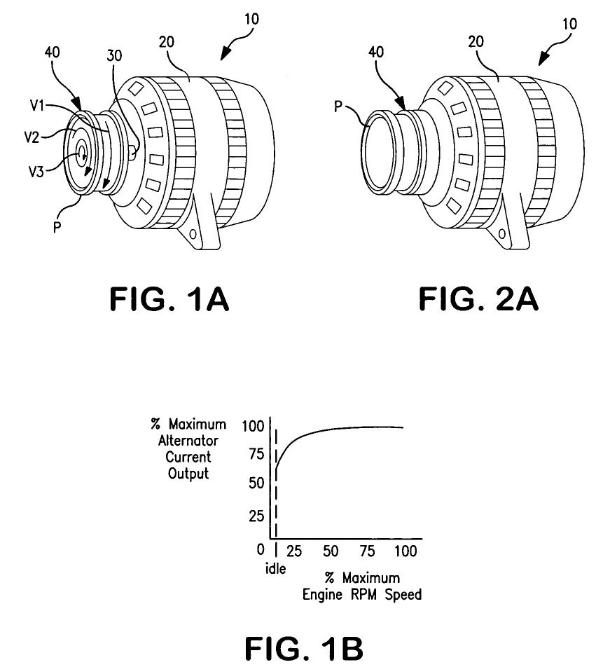

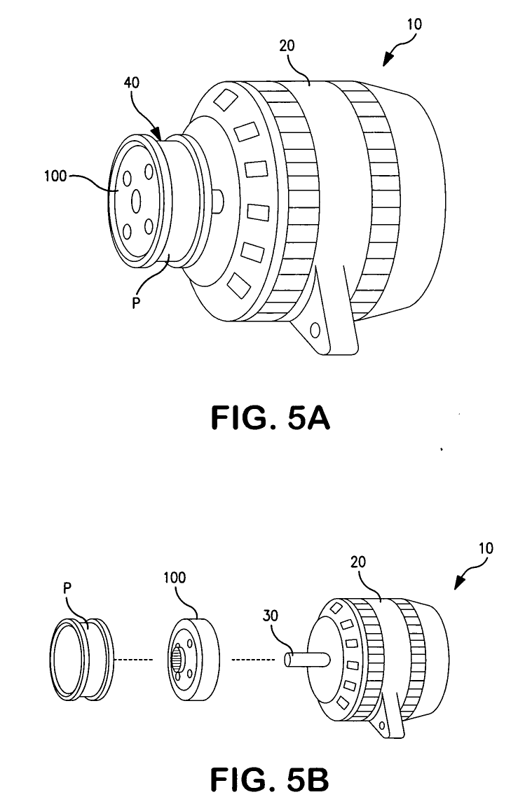

Referring generally to FIGS. 1A-8B, the invention comprehends various improved power conversion devices, including electrical power generating alternator assemblies, namely overdrive modulating alternators 10. Overdrive modulating alternators 10 maintain a desired range of current outputs regardless of the operating, i.e. angular, speed of the internal combustion engine to which they are connected. Accordingly, overdrive modulating alternators 10 rotate at angular speeds much higher than the angular speed of the engine at idle, thereby producing a substantial amount of current while the engine is running at idle speed. Thus, overdriven alternators of the invention provide a generally constant amount of current, near the maximum or rated current output of the device, typically within the entire range of normal operating speeds for the engine, namely at all speeds, including idle speed, between idle speed and the wide open throttle condition. Referring to FIG. 1B, even at idle speed, the rotational speed of the alternator is in the flat portion of the output curve whereby substantially the entirety of engine speeds corresponds to the flat, maximum output, portion of the output curve for the alternator.

In typical implementations, overdrive modulating alternator 10 is operably connected to or otherwise driven by e.g. an internal combustion engine. An overdrive modulating alternator 10 is typically connected to an internal combustion engine, e.g. connected to the engine crankshaft pulley, by way of, for example, a V-belt, a serpentine belt, and/or other suitable device or method.

The internal combustion engine which utilizes such overdrive modulating alternator 10 is, in turn, used in any of a variety of suitable end use devices, vehicles such as watercraft and aircraft and/or other end use configurations. In other words, overdrive modulating alternators 10 are suitably used in generally all implementations of internal combustion engines, including, but not limited to, passenger cars and other passenger vehicles, motorcycles, freight vehicles, aircraft, tractors, recreational vehicles such as all-terrain-vehicles, outboard engine power boats and other boats, RV-campers, as well as non-vehicle implementations such as e.g. portable and other engine driven welders, compressors, pumps, generators, and/or others. Thus, overdrive modulating alternators 10 are generally suitable for all end uses which employ an alternator to convert mechanical energy, from the output shaft of a variable-speed internal combustion engine, to electrical energy.

As mentioned, the electrical current output produced by overdrive modulating alternator 10 stays generally within a desired range of output current, over a wide range of angular engine speeds. The particular range of desired alternator current output values depends on e.g. the particular maximum output rating of the alternator, the end use electrical demands, and the persistent use rate of consumption of electrical power. Such optimum or desired current output range typically includes but is not limited to, (i) between 60 percent of maximum rated alternator output and maximum rated alternator output, (ii) between 70 percent of maximum rated alternator output and maximum rated alternator output, (iii) between 80 percent of maximum rated alternator output and maximum rated alternator output, (iv) between 90 percent of maximum rated alternator output and maximum rated alternator output, and/or (v) other ranges, wider or narrower, as desired based on e.g. the particular energy consumption needs of the intended end-use, both peak needs and persistent or ongoing needs. Such alternator output at idle engine speed should be sufficient to at least provide for the ongoing persistent demands on the electrical system while the engine is at idle speed. And so long as the maximum overdrive ratio is great enough to drive the alternator at a speed in the flat part of the output curve such as in FIG. 1B, and the overdrive ratio is modulated as engine speed increases, alternator output is relatively constant over the full range of engine speeds, without overdriving the alternator at speeds which are destructive to the alternator.

To achieve such result, the rotor of overdrive modulating alternator 10 rotates within a desired range of rotational velocities, optionally at a generally constant optimum rotational velocity above a relatively low threshold engine speed, to output a desired amount of current which is generally less affected by operational speed of the associated internal combustion engine than if the alternator output speed were not modulated as in the invention.

Referring now to FIGS. 1A, 2A, 3A, 4A, 5A, 6A, 7A, and 8A, each overdrive modulating alternator 10 includes an alternator body 20, an alternator input shaft 30 which respectively extends axially outwardly from the alternator body, and an overdrive modulating assembly 40 which in turn includes a planetary gear set 100. A pulley “P” is connected to the overdrive modulating assembly 40 and transmits torque to the overdrive modulating assembly.

Overdrive modulating assembly 40 enables the alternator to operate within a desired current output range regardless of speed of rotation of the engine, without overdriving the alternator at any engine speed and without stepping the alternator through any pre-determined stepped set of various discrete gear ratios. Thus, overdrive modulating assembly 40 is not limited to a defined number of gear ratios. Rather, through e.g. modulation, the overdrive modulating assembly 40 functions as, for example, a continuously variable force transmission device, an infinitely variable force transmission device, and/or other device capable of smoothly and continuously varying the input/output rotational speed ratio, also known as the overdrive ratio, at an infinite number of potential ratios between uppermost and lowermost input/output ratios, from free-wheeling condition to fully locked up condition.

Overdrive modulating assembly 40 thus defines an infinitely variable overdrive ratio between maximum and minimum ratios. The magnitude of the overdrive ratio at any given pointing time is a function of the rotational velocity of pulley “P” and thus engine rotational speed, and varies according to the magnitude of the rotational velocity of pulley “P” and thus engine rotational speed relative to alternator shaft speed. In other words, based on the continuously variable force transmission functionality of assembly 40, assembly 40 can be infinitely modulated, between a maximum assembly input speed and a maximum assembly output speed, so as to vary its output rotational velocity with respect to its corresponding input rotational velocity, and wherein the output rotational velocity is a function of the magnitude of the input velocity as modified by the modulating affect of modulating assembly 40.

Referring now to FIG. 1A, by modulating various ones of the components of overdrive modulating assembly 40, the real-time overdrive ratio of the device is established. Consequently, various rotational velocities and their relationship(s) to each other are defined during use of overdrive modulating alternator 10, at various components thereof.

Namely, the rotational velocity of pulley “P” defines a first rotational velocity, illustrated in FIG. 1A as “V1.” The rotational velocity of the illustrated modulated portion or component of overdrive modulating assembly 40 is illustrated as “V2.” The rotational velocity of the output of overdrive modulating assembly 40 is illustrated as “V3.”

Accordingly, the rotational velocity differential, defined between rotational velocities “V1” and “V3,” influences, at least partially determines, and at least in part defines, the real-time and instantaneous overdrive ratios of the device. It is this V3/V1 rotational velocity differential which continuously varies over time, as influenced by the magnitude of rotational velocity “V1” of pulley “P”, as driven by the engine to which the pulley is connected.

As explained in greater detail below, the degree, amount, or extent, of modulation applied to modulating assembly 40 influences the magnitude of rotational velocity “V2.” Accordingly, while the relationship between the pulley “P” rotational velocity “V1” and the crankshaft pulley rotational velocity is linear and constant (defined by the relative circumferences of each), as the degree, amount, or extent, of modulation applied to modulating assembly 40 changes or varies in magnitude over time, so too does the realized instantaneous overdrive ratio and differential between the rotational velocities “V1” and “V3.”

Stated another way, the ratio of various ones of the rotational velocities, namely the ratio of pulley “P” rotational velocity “V1” to alternator input shaft velocity “V3” varies continuously with only incremental changes, thus relatively speaking no step changes, between instantaneous ratios of V3/V1. Accordingly, while the overdrive ratio smoothly and continuously changes between e.g. maximum and minimum overdrive ratios, no shock loads, no periodic clutching, are realized at the overdrive modulating assembly 40 or elsewhere in the entire assemblage of overdrive modulating alternator 10.

The operating characteristics of various components within modulating assembly 40, for example rotational velocity, are modulated continuously to create the desired continuously variable overdrive ratio of the device, which ratio is generally free from multiple step changes within the operating speed range of the engine. Namely, the smooth transition from e.g. the overdrive ratio at idle speed, during engine acceleration, is accomplished by applying a modulating force to one or more components of overdrive modulating alternator 10, as explained in greater detail elsewhere herein. Accordingly, by modulating such various ones of the components of overdrive modulating alternator 10, the alternators can function as, for example, (i) an overdriven alternator wherein the alternator rotor rotates at a relatively greater rotational angular speed, at engine idle, than the angular speed of the alternator drive pulley, (ii) a continuously variable speed overdriven alternator wherein the alternator rotor rotational velocity can continuously vary as compared to the alternator drive pulley rotational velocity, optionally (iii) a direct drive alternator at pulley lock-up speed wherein the alternator rotor rotates at or proximate the same rotational velocity as the alternator drive pulley, and optionally (iv) an underdriven alternator wherein the alternator rotor rotates at a relatively lesser angular speed than the angular speed of the alternator drive pulley, all without any step changes in rotational velocity of the alternator rotor.

For example, modulating alternator 40 achieves a minimum overdrive ratio of e.g. about 4/1 to about 6/1 at engine idle speed. Where engine idle speed is e.g. 700 rpm, alternator shaft speed, at engine idle speed, is about 2800 rpm to about 4200 rpm whereby a typical vehicle alternator is producing maximum or near-maximum power output at engine idle. As engine speed is increased, the overdrive ratio is controllably reduced so as to not drive the alternator beyond its rated maximum angular speed of rotation, which rated maximum angular speed of rotation is typically about 15,000 rpm. By the time engine speed has neared maximum, the overdrive ratio has been reduced to approximately 1/1 whereby the modulating assembly approaches, or achieves lock-up whereby the angular speed of the alternator approximately matches, indeed may match, the angular speed of pulley “P”.

Alternator body 20 is, for example, a conventional alternator device, optionally a generator or dynamo, and/or other electric power generating device, all of which are hereinafter referred to as an alternator. The alternator includes an alternator housing which fixedly houses a stator assembly and rotatingly houses a rotor assembly. In some embodiments, the alternator can further include various other components such as, and without limitation, various ones of diodes, voltage regulators, exciters, and/or rectifiers, depending on the particular configuration of the alternator.

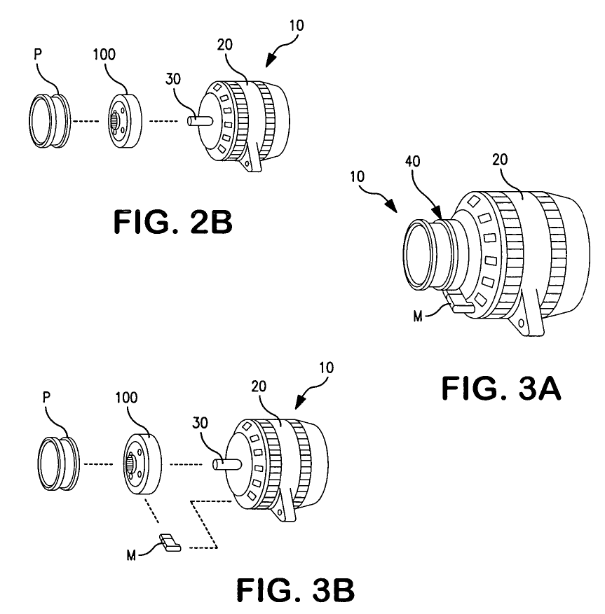

Referring now to FIGS. 2B, 3B, 4B, 5B, 6B, 7B, and 8B, alternator input shaft 30 communicates and cooperates with the alternator rotor assembly, whereby the alternator rotor assembly rotates in unison with alternator input shaft 30. Alternator input shaft 30 is driven by the output portion of overdrive modulating assembly 40. Accordingly, in embodiments in which alternator shaft 30 is directly connected to the output portion of overdrive modulating assembly 40, alternator shaft 30 rotates in rotational unison therewith, whereby shaft 30 also rotates at rotational velocity “V3” (FIG. 1A).

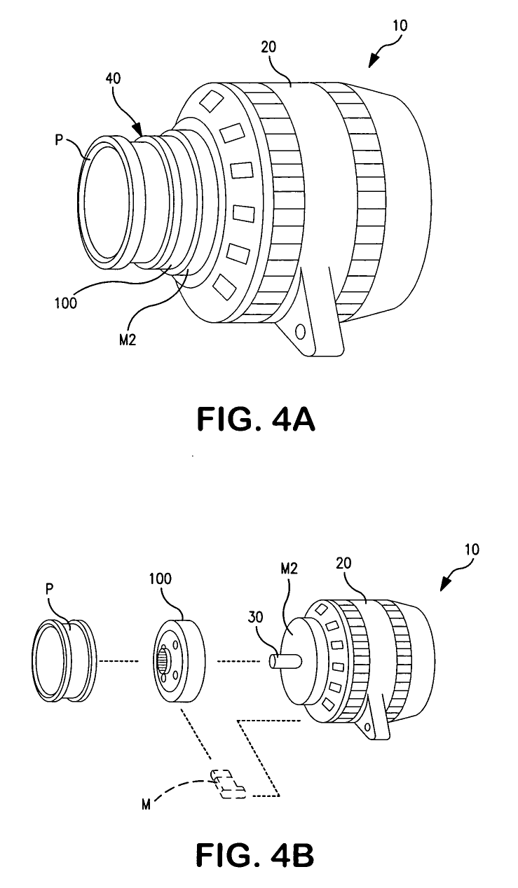

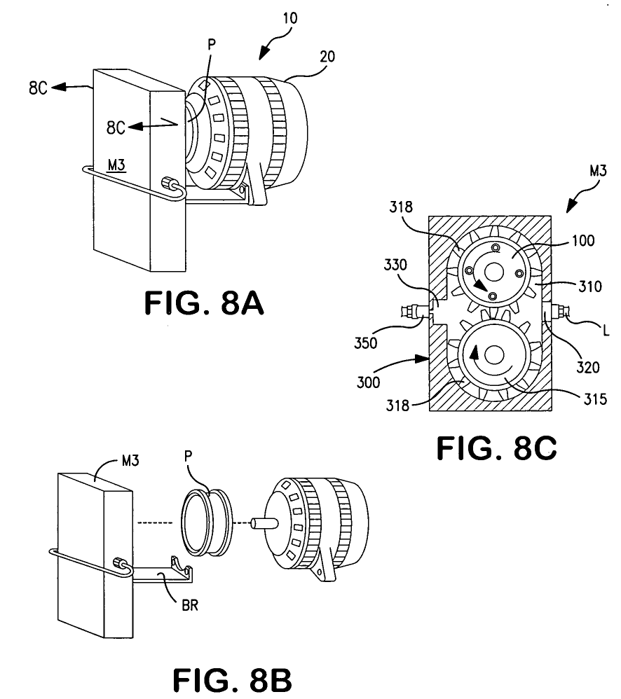

Overdrive modulating assembly 40 is the mechanical interface between the outer surface of driven pulley “P” and alternator input shaft 30 and transmits torque between pulley “P” and alternator input shaft 30. In some embodiments overdrive modulating assembly 40 is generally self-modulated and/or passively modulated (explained in greater detail elsewhere herein), while in other embodiments modulating assembly 40 is generally actively modulated based on various operating conditions or circumstances. As desired, overdrive modulating assembly 40 further includes at least one external or ancillary modulation device, e.g. modulation device “M” (FIG. 3A), modulation device “M2” (FIG. 4A), modulation device “M3” (FIG. 8A) or the like.

During use, the driving force provided by the crankshaft pulley of the internal combustion engine is transmitted through the e.g. belt, thence through pulley “P” and into and through the infinitely variable force transmission device, namely through planetary gear set 100. Planetary gear set 100 is modulated either internally or externally, whereby the output rotational velocity of the device is influenced not only by the input rotational velocity of pulley “P” but also by the magnitude of the modulating force applied to or generated within modulating assembly 40, which in turn influences the real-time overdrive ratio by which the alternator rotor is rotatingly driven, with respect to the rotation of pulley “P”.

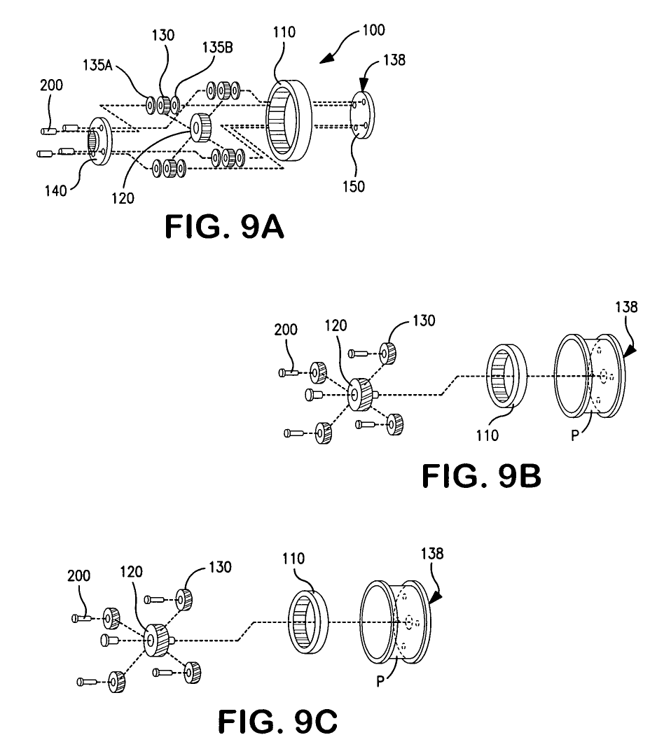

Referring now to FIGS. 9A, 9B, 9C, 10A, 10B, 11A, and 11B, planetary gear set 100 includes ring gear 110, sun gear 120, planet gears 130, optionally alignment plates 135A, 135B, and planet carrier 138. Planet carrier 138 includes e.g. ones of flanges 140 and 150 and a plurality of pinions or shafts, namely pinions 200 and rotatingly houses planet gears 130 therein. Planetary gear set 100 can be and includes any of a variety of suitable epicyclic gear trains, which produce the desired result(s).

Ring gear 110 is generally cylindrical, having an opening which extends axially therethrough, e.g. has first and second generally annular end surfaces which define a length dimension therebetween. The outer circumferential surface of ring gear 110 is generally smooth and in some embodiments is adapted and configured to interface and cooperate with e.g. modulation assembly “M” and/or modulation assembly “M2”. A plurality of gear teeth or spurs extend about the entire inner circumferential surface of ring gear 110, whereby the ring gear defines a toothed inwardly facing surface. The toothed inner circumferential surface of ring gear 110 is adapted and configured to mesh, interface, and cooperate with other components of planetary gear assembly 100, namely planet gears 130.

Sun gear 120 is generally cylindrical, having a bore which extends axially therethrough, e.g. sun gear 120 has first and second generally annular end surfaces which define a length dimension therebetween. A plurality of gear teeth or spurs extend about the entire outer circumferential surface of sun gear 120, whereby the sun gear defines a toothed outwardly facing surface. The outer surface teeth or spurs of sun gear 120 are adapted and configured to mesh, interface, and cooperate with planet gears 130.

The inner bore of sun gear 120 is axially splined, whereby sun gear has inwardly facing splines. The bore splines of sun gear 120 are adapted and configured to cooperatively engage outwardly facing splines of alternator input shaft 30. In other words, alternator input shaft 30 has a splined end to which sun gear 120 is splined/mounted, whereby sun gear 120 rotates in rotational unison with input shaft 30. Accordingly, sun gear 120 is the only component of overdrive modulating assembly 40 which transmits torque from the overdrive modulating assembly 40 to the alternator input shaft 30, thereby defining a single path of torque transmission between the overdrive modulating assembly 40 and the alternator input shaft 30.

However, as desired, other components of overdrive modulating assembly 40 can be connected to input shaft 30, for rotational unison, in lieu of sun gear 120, whilst still achieving a single path of variable rate torque transmission between modulating assembly 40 and alternator input shaft 30, and for achieving a different overdrive, or underdrive, ratio relative to the angular speed of pulley “P”. As one example, as desired, ring gear 110 can include a cover, cap, rigid sleeve, or other suitable structure which is fixedly connected to input shaft 30. As another example, as desired, planet carrier 138 can include a cover, cap, rigid sleeve, or other suitable structure which is fixedly connected to input shaft 30.

Each of planet gears 130 is generally cylindrical, having a bore which extends axially therethrough, e.g. each planet gear has first and second generally annular end surfaces which define a length dimension therebetween. A plurality of gear teeth or spurs extend about the entire outer circumferential surface of each of planet gears 130, whereby each planet gear defines a toothed outwardly facing surface.

The outer surface teeth or spurs of a planet gear are thus adapted and configured to mesh, interface, and cooperate both with corresponding teeth or spurs on the inner circumferential surface of ring gear 110 and with the teeth or spurs on the outer circumferential surface of sun gear 120. In other words, ones of planet gears 130 extend radially between the ring gear and the sun gear.

The inner bore of a planet gear 130 preferably has smooth surface characteristics, whereby the planet gear 130 is adapted and configured to slidingly house e.g. a pinion or shaft therethrough, whereby the planet gears 130 can rotate freely upon such pinion or shaft.

In some embodiments, overdrive modulating assembly 40 further includes at least one alignment plate, e.g. alignment plate 135A and/or 135B. Each of alignment plates 135A 135B is generally circular in perimeter and planar in profile. Bores extend axially through the centers of the alignment plates 135A, 135B. Like the through bores of planet gears 130, the bores of alignment plates 135A, 135B are adapted and configured to slidingly house e.g. the pinions or shafts which extend through the respective gears 130, whereby the alignment plates 135A, 135B, as well as gears 130, can rotate freely relative to such pinion or shaft.

As visible in FIG. 9A, respective pairs of alignment plates 135A, 135B are registered and coaxially aligned with ones of planet gears 130. Alignment plate 135A and alignment plate 135B lie on opposite sides of a given planet gear 130.

In some embodiments, the diameters of the alignment plates 135A, 135B are greater in magnitude than the magnitude of the diameter of the root circle of the respective planet gear 130. In such embodiments, the outer perimeters of corresponding pairs of alignment plates 135A, 135B extend past and over the ends of the relevant portions of the teeth or spurs of the sun gear and/or the ring gear. In other words, alignment plates 135A, 135B mechanically define e.g. the amount of axial or horizontal runout or float of the planet gears 130 with respect to the sun gear and/or ring gear.

Accordingly, when relatively less axial or horizontal runout or float of the planet gears 130 is desired with respect to the sun gear and/or the ring gear, the distance between alignment plates 135A and 135B more closely corresponds to or resembles the magnitude of the width dimension of the sun and/or ring gear. Likewise, when relatively more axial or horizontal runout or float of the planet gears 130 is desired, with respect to the sun gear and/or the ring gear, the distance between alignment plates 135A and 135B is relatively greater than the magnitude of the width dimension of the sun gear and/or the ring gear, whereby the planets can float axially relatively more with respect to e.g. the relatively fixed width planet carrier 138.

Planet carrier 138 is, in some embodiments, driven by pulley “P”. Accordingly in some embodiments, planet carrier 138 is mechanically attached to pulley “P”. In some embodiments, pulley “P” is integrally connected to planet carrier 138, whereby planet carrier 138 also functions as, for example, a circular endwall of pulley “P” (FIG. 9B). In alternative embodiments, as desired, pulley “P” is part of, or connected to, ring gear 110, whereby the rotational torque of pulley “P” is transmitted to the ring gear (FIG. 9A) instead of planet carrier 138 as shown in FIG. 9B.

First flange 140, as illustrated, has a generally circular outer perimeter and a generally circular splined collar which extends from a medial portion thereof. A bore, having a splined inner surface, extends axially and medially through both the collar and the main body portion of first flange 140.

Second flange 150 has a generally circular outer perimeter and is substantially an analog of flange 140, without the splined collar. It should be noted that flanges 140 and 150, in some embodiments, have other suitable configurations. As one example, in some embodiments, the splined collar of first flange 140 has a splined outer circumferential surface, in lieu of or in addition to a splined inner circumferential surface.

In some embodiments, flange 140 is devoid of any such splined collar(s). In some embodiments, ones of flanges 140 and 150 have apertures which extend therethrough, medially or otherwise. In yet other embodiments, flanges 140, 150 define continuous surfaces and have no such apertures. Regardless, ones of flanges 140, 150 are adapted and configured to suitably cooperate and interface with e.g. pulley “P”, whereby the particular sizes, shapes, and configurations of the flanges correspond to the intended setup, design, and configuration of other components of overdrive modulating assembly 40.

Each of pinions 200 is a generally elongate, cylindrical, shaft-like member. Pinions 200 extend through respective ones of planet gears 130, optionally also through ones of alignment plates 135A, 135B. Accordingly, pinions 200 are adapted and configured to rotatably carry planet gears 130 and alignment plates 135A, 135B thereon and generally define the respective axes of rotation of the planet gears, and alignment plates. In some embodiments, pinions 200 have, for example a shoulder or larger diameter portion thereof, or a head-type structure at an end (FIGS. 9B, 9C).

Ones of the pinions 200 are laterally spaced from each other by distances which correspond to the distances between adjacent planet gears 130. The ends of pinions 200 are connected to first and second flanges 140, 150; namely, the pinions span between the flanges. Thus, a first end of pinion 200 interfaces with flange 140 and the second end of pinion 200 interfaces with flange 150, connecting the flanges to each other.

In some embodiments, pinion 200 includes at least one relatively larger diameter shoulder portion which is adapted and configured to, for example, mechanically limit or interfere with the axial or horizontal runout or float of the planet gears 130 and alignment plates 135A, 135B.

Referring to the complete assemblage of overdrive modulating assembly 40, the planet gears 130 are mounted to and rotate upon pinions 200, within planet carrier 138. Each of the planet gears 130 engages both the inside of ring gear 110 and the outside of sun gear 120. Accordingly, the particular output rotational velocity and/or gear ratio of modulating assembly 40 depends on where, in the planetary gear set, the input energy is applied, and where in the planetary gear set, the output energy or torque is withdrawn.

Torque can be applied or inputted at any one of e.g. ring gear 110, sun gear 120, or planet carrier 138, as desired. Correspondingly, torque can be withdrawn from modulating assembly 40 at any of e.g. corresponding other ones of ring gear 110, sun gear 120, or planet carrier 138, as desired. To influence the real time output ratio and modulating characteristics of planetary gear set 100, any of one of ring gear 110, sun gear 120, or planet carrier 138, can be modulated, depending on which gear set component(s) torque is applied to and removed from.

Restated, torque is inputted into assembly 40 at a first one of ring gear 110, sun gear 120, and carrier 138, torque is outputted from assembly 40 at a second one of ring gear 110, sun gear 120, and carrier 138, and assembly 40 is modulated by controlling the rotation of the third one of ring gear 110, sun gear 120, or carrier 138.

In some embodiments, torque is inputted from pulley “P” into the planetary gear set at either the ring gear 110 or the planet carrier 138. In both such embodiments, torque is removed from planetary gear set 100 by way of sun gear 120 and the non-torque-inputted, i.e. the other, one of ring gear 110 and planet carrier 138, is modulated to influence the instantaneous overdrive ratio realized at planetary gear set 100.

Stated another way, although output torque can be captured from any of the ring gear 110, sun gear 120, and planet carrier 138, the output torque of planetary gear set 100 is typically captured at sun gear 120 and transmitted thence to alternator input shaft 30.

Since, during use, the alternator input shaft 30 provides some resistance to rotation when an input torque is applied to ring gear 110, planet carrier 138 is correspondingly urged into rotation. If no resistive force is applied to planet carrier 138, then the carrier will generally freely rotate or freewheel, whereby the alternator input shaft 30 and sun gear 120 remain static.

Accordingly, while in use, a modulated force and/or pressure is exerted against the planet carrier to retard, drag, and/or otherwise resist rotation of the planet carrier. Namely, the force applied to planet carrier 138 is a modulating force which changes in magnitude over time such that the planet carrier rotational velocity varies inversely with respect to the rotational velocity of ring gear 110 and thus also with the engine speed.

At relatively low engine speed, such as at or near idle, a relatively greater in magnitude modulating force is applied, which mitigates the rotational velocity, optionally stops rotation, of planet carrier 138. Correspondingly, by mitigating, fully retarding, or stopping, the rotation of planet carrier 138, the rotational velocity differential between the (i) pulley and ring gear rotational velocity “V1” and (ii) sun gear and input shaft 30 rotational velocity “V3” is at its greatest value (FIG. 1A) and thus the instantaneous overdrive ratio is at or near its maximum value.

The particular overdrive value is selected based on the rotational velocity of pulley “P” at engine idle speed and the rotational velocity needed by alternator input shaft 30 to enable the alternator to produce the desired current output, as well as the diameter of the sun gear. Exemplary, non-limiting maximum over drive ratios are 2:1, 3:1. 4:1, 5:1, 6:1, 7:1, 8:1, and/or others as desired.

At relatively high engine speed, such as at or near wide open throttle, the modulating force is applied at a relatively small magnitude, whereby there is relatively little mitigation or retarding of the rotational velocity of planet carrier 138. Correspondingly, at least some of the input torque is used to rotate planet carrier 138 at a relatively great rotational velocity, whereby the rotational velocity V3/V1 ratio defined between the (i) the sun gear and input shaft 30 rotational velocity “V3” and (ii) the pulley and ring gear rotational velocity “V1” is at its smallest value as the magnitudes of “V3” and “V1” approach each other (FIG. 1A). In other words, at high engine speeds, the instantaneous overdrive ratio V3/V1 is at or near its minimum value, approaching a 1/1 ratio.

In embodiments in which the ring gear 110 is driven by pulley “P”, drive torque on the planet carrier 138 is modulated and the minimum instantaneous overdrive ratio is necessarily always greater than 1/1 so that the alternator always produces an electrical output. Namely, when ring gear 110 is driven and planet carrier 138 is modulated, the sun gear 120 rotates in the opposite direction of the ring gear. However, if a 1/1 drive ratio were realized through planetary gear set 100, the various components in the device rotate in rotational unison which requires a rotational direction change on part of sun gear 120 relative to ring gear 110. Such direction change suggests that at some point in the modulation, rotation of the sun gear would slow down, stop, and then resume in the opposite direction. In that process, the literal slowing down and stopping of the sun gear implies slowing down and stopping of the alternator, which is not acceptable. Accordingly, where the ring gear is driven, the modulation speed window is necessarily kept relatively smaller to the extent that the modulation can never allow the alternator speed to slow down below that speed where the alternator provides suitable power output; nor can the modulation cause the alternator to stop.

In such case where the modulation speed window is limited, a more positive external control system can be used. Such control system can employ sensors which directly or indirectly sense both the angular input speed of the pulley device or ring gear, and the angular output speed of the sun gear or the alternator shaft, to provide sensed data from the sensors to a controlling computer. The computer provides modulation commands to the carrier thus to modulate the input/output ratio of modulator assembly 40 so as to maintain the rotational speed of the sun gear, thus the alternator, within its range of rotational operating speeds wherein the alternator provides a desired amount of power output sufficient to adequately meet the needs of the watercraft or other vehicle or device in which it is mounted.

When an input torque is applied to planet carrier 138, ring gear 110 is correspondingly urged into rotation. If no resistive force is applied to ring gear 110, then the ring gear will generally freely rotate or freewheel, whereby the alternator input shaft 30 and sun gear 120 remain static.

Accordingly, while in use, a modulatingly applied force and/or pressure is exerted against the ring gear to retard or otherwise resist its rotation. Namely, the force applied to ring gear 110 is modulated and/or otherwise changes in magnitude over time such that the ring gear rotational velocity varies inversely with respect to the rotational velocity of planet carrier 138 and thus also with the engine rotational speed.

It follows that at relatively low engine speed conditions such as at or near idle, the modulating force has a relatively great magnitude which mitigates the rotation velocity, optionally stops rotation, of ring gear 110. Correspondingly, by mitigating, fully retarding, or stopping, the rotation of ring gear 110, the rotational velocity differential V3/V2 defined between the (i) the pulley and planet carrier rotational velocity “V2” and (ii) the sun gear and input shaft 30 rotational velocity “V3” is at its greatest value (FIG. 1A) and thus the instantaneous overdrive ratio is at its maximum value.

At relatively high engine speed conditions such as at or near wide open throttle, the modulating force is relatively reduced, whereby there is relatively little mitigation or retarding of the rotational velocity of ring gear 110. Correspondingly, at least some of the input torque is used to rotate ring gear 110 at a relatively great rotational velocity, whereby the rotational velocity differential defined between (i) the pulley and planet carrier rotational velocity “V2” and (ii) the sun gear and input shaft 30 rotational velocity “V3” is at its smallest value as the magnitudes of “V1” and “V3” approach each other (FIG. 1A). In other words, at high engine speeds, the instantaneous overdrive ratio is at its minimum value, approaching or equaling a 1/1 ratio.

In embodiments in which the planet carrier 138 is driven by the pulley “P”, drive torque at ring gear 110 is modulated and the minimum instantaneous overdrive ratio can equal 1/1 or a direct drive ratio. This is because when planet carrier 138 is driven and ring gear 110 is modulated, the sun gear 120 rotates in the same direction as the planet carrier.

Thus, the instantaneous output rotational velocity of overdrive modulating assembly 40 depends at least in part on (i) whether the input torque drives ring gear 110, sun gear 120, or planet carrier 138, (ii) whether the output torque is taken from ring gear 110, sun gear 120, or planet carrier 138, and (iii) on the magnitude of the modulating force which is applied to the device at that particular instant.

In some embodiments, planetary gear assembly 100 is self or passively modulating, by way of e.g. fluid coupling principles, hydraulic principles, and/or otherwise. In other embodiments, an external modulating device e.g. modulation assembly “M” and/or modulation assembly “M2”, and/or others, are used to modulate various components of the overdrive modulating assembly, such as the exemplary modulating devices illustrated in FIGS. 3A, 4A, 4B, 6A, 6B, 7A, 7B, and elsewhere.

Regardless of the particular methods and devices used to modulate components of planetary gear set 100, overdrive modulating assembly 40 provides a continuously variable overdrive ratio which transitions between the maximum and minimum overdrive ratios, generally smoothly and inversely with respect to engine speed. Such continuous modulation transition is accomplished by utilizing a single path of torque transmission from pulley “P” through overdrive modulating assembly 40 and to alternator input shaft 30, whereby the entire assemblage of the device is devoid of one-way clutches, overrunning clutches, one-way bearings, overrunning bearings, sprag-type devices, freewheel devices, and/or other devices which enable e.g. a first shaft to rotate at a greater, and uncontrolled, rotational velocity than a second shaft.

In other words, modulation is done in any of a variety of suitable ways which are selected based on the particular intended end use environment, desired performance characteristics, and/or others. The modulation, passive or active, is preferably accomplished by way of e.g. mechanical modulation, electromechanical modulation, fluid-based modulation, chemical modulation, and/or other modulation methods and techniques suitable to slow, slip, retard, impede, modify, adjust, regulate, hold, partially hold, and/or otherwise influence the rotational velocity and/or other operating characteristics (as appropriate) of the respective modulated components, be it ring gear 110, planet carrier 138, or sun gear 120.

Referring to fluid-modulation methods, techniques, and devices, fluid modulation is achieved by way of (i) fluid, liquid, or viscous coupling characteristics and events within the overdrive modulating assembly 40, (ii) hydraulic circuitry, (iii) electrorheological fluids and corresponding variable intensity electric fields, and/or (iv) others.

A first exemplary fluid coupling assembly includes overdrive modulating assembly 40, and a liquid or other fluid sealed inside assembly 40, which fluid has suitable weight, viscosity, and/or other characteristics to modulate the input driving force at high-output operating speeds of the engine. During use, as pulley “P” rotates planet carrier 138, ones of the planet carrier 138 and planet gears 130 generally function as analogues of an impeller within a conventional fluid coupling. Ring gear 110 generally functions as an analogue of a runner within a conventional fluid coupling.

Accordingly, while rotating about their respective axes, planet carrier 138 and planet gears 130 sling and accelerate fluid from their respective axes and off their outer peripheral surfaces. The mass of slung fluid then travels at a relatively high velocity toward ring gear 110 and impinges on e.g. the ring gear teeth.

When the combination of the mass of the fluid and the velocity at which the fluid is slung from planet carrier 138 and/or planet gears 130 is sufficiently large in magnitude, the momentum of the fluid overcomes the inertia of the ring gear, whereby the ring gear begins to rotate in e.g. the same direction as planet carrier 138. In other words, ring gear 110 begins to fluidly couple with planet carrier 138. As planet carrier 138 rotates relatively faster, the fluid coupling force correspondingly increases, whereby the difference between the angular velocity of planet carrier 138 and ring gear 110 are mitigated.

Then, at a sufficiently great rotational velocity of planet carrier 138, ring gear 110 is completely fluidly coupled to planet carrier 138. At this point, ring gear 110, sun gear 120, and planet carrier 138 are locked into rotational unison with each other. In other words, overdrive modulating assembly 40 is “locked-up” and the alternator input shaft 30 rotates at the same angular rotational velocity as pulley “P.”

In some embodiments, to increase the efficiency of the fluid coupling, the inwardly facing surfaces of flanges 140 and 150 have blades or other structures which extend inwardly therefrom, thereby increasing the fluid slinging capacity of overdrive modulating assembly 40 while planet carrier 138 rotates.

In other embodiments, an external fluid coupling device is used, e.g. the fluid coupling occurs outside of overdrive modulating assembly 40. In a first embodiment of such external fluid coupling devices, each of ring gear 110 and planet carrier 138 has an adjacent fluid cavity extending axially therefrom. The planet carrier fluid cavity includes a plurality of impeller blades. The ring gear cavity includes a plurality of runner blades. The planet carrier and ring gear fluid cavities are in fluid communication, analogous to a typical fluid coupling device. Accordingly, the planet fluid cavity acts as a pump and the ring gear fluid cavity acts as a driven turbine, whereby at a sufficiently high rotational velocity, the planet carrier 138 and ring gear 110 fluidly couple with, and are locked into rotational unison with, each other.

In yet other embodiments, the amount of fluid in the fluid coupling portion of the device is metered and/or otherwise controlled by a valve or variable sized orifice and corresponding valve control mechanism(s). Exemplary of a suitable valve control mechanism is a bimetallic or other thermostatic spring, which opens or closes the valve based on any of a variety of operating conditions including e.g. various operating pressures and/or operating temperatures, similar to those used in automotive thermostatic fan clutches and/or viscous dampers. Another suitable valve control mechanism is a centrifugally biased device which opens or closes the valve base on, for example, the rotational velocity of planet carrier 138.

In one such embodiment, the modulating device is a typical viscous damper which interfaces with and communicates with the modulated portion of planetary gear set 100. Due to space constraints and manufacturing ease, the viscous damper device preferably extends axially from and is registered with planetary gear set 100.

Referring now to FIGS. 8A, 8B, and 8C, in some embodiments, the fluid-modulating device includes a defined hydraulic circuit assembly, illustrated as modulation device “M3”. Within modulation device “M3”, hydraulic fluid flow is metered, which creates the modulation effect within overdrive modulating assembly 40.

Modulation device “M3” includes housing 300, cavity 310, idler gear 315, suction port 320, pressure port 330, valve 350, and planetary gear set 100. Housing 300 has a plurality of walls which in combination define a generally liquid tight enclosure. A void portion within housing 300 defines cavity 310.

Cavity 310 is adapted and configured to house various components of modulation device “M3” therein. Namely, cavity 310 rotatingly houses planetary gear set 100 and idler gear 315 therein. In addition, cavity 310 holds a relatively fixed amount of e.g. hydraulic fluid, which the various other components of modulation device “M3” are adapted and configured to pump and/or otherwise circulate therethrough. In other words, cavity 310 generally defines an oil bath in which the other components are housed.

Planetary gear set 100 of FIG. 8C is similar to those described elsewhere. For example, planetary gear set 100 is adapted and configured to be driven through, or by, its planet gear and modulated through its ring gear. One noted structural difference in planetary gear set 100 of FIG. 8C is that the outer circumferential surface of the ring gear has a plurality of teeth or paddles extending radially therefrom, e.g. teeth 318. Teeth 318 of planetary gear set 100 are adapted and configured to cooperate and interface with corresponding teeth 318 of idler gear 315.

Idler gear 315 has generally the same outer dimensions as planetary gear set 100, including a plurality of teeth 318 extending radially from its outer circumferential surface. Thus, idler gear 315 and planetary gear set 100 are adapted and configured to cooperate and interface with each other.

The outer radii of portions of cavity 300 correspond closely to radii defined by lines tangent to the outermost portions of teeth 318. Accordingly, in the entire assemblage of modulation device “M3”, planetary gear set 100 and idler gear 315 are aligned with each other and snugly fit within cavity 310, while permitting rotation therein.

Due to the relatively small clearances between the cavity 310 walls and the outermost portions of teeth 318, as planetary gear set 100 and idler gear 315 rotate, in the directions indicated in FIG. 8C, the gear teeth come into and out of mesh with respective ones of each other to create flow, similar to e.g. some automotive-style oil pumps or pumps referred to by some as external gear pumps.

So, in use, pulley “P” rotatingly drives the planet carrier which in turn, due to fluid coupling principles created by the fluid within the gear set, drives the remainder of planetary gear set 100 and also idler gear 315.

As planetary gear set 100 and idler gear 315 come out of mesh, near the right side portion of FIG. 8C, the separation of teeth 318 creates an expanding volume near the hydraulic line, i.e. line “L”. This expanding volume creates a low pressure portion within cavity 310, namely at suction port 320, which draws hydraulic fluid from line “L” thereinto.

Hydraulic fluid travels from suction port 320 inwardly into cavity 310. From here, the gear teeth 318 scoop and trap the fluid between the teeth 318 and the cavity wall, during rotation, pulling and/or pushing the fluid along as gear set 100 and idler gear 315 rotate.

On the other side of the cavity, namely the left side of cavity 310 illustrated in FIG. 8C, the teeth of gear set 100 and idler gear 315 come back into mesh with each other. In so doing, the fluid is squeezed out from between the intermeshing teeth and pushed into the left hand portion of the cavity 310. This creates a relatively high pressure environment at or adjacent e.g. pressure port 330, which opens into valve 350. Valve 350 in turn opens into the second end of line “L”, which completes the hydraulic circuit within the device.

Valve 350 meters or otherwise controls the flow through the above described hydraulic circuit. In other words, the magnitude of the pressure within port 330 is related to the volume of fluid which valve 350 allows therethrough, as related to the rate at which fluid is entering pressure port 330.

Accordingly, when valve 350 allows relatively little or no hydraulic fluid therethrough, pressure continues to build within pressure port 330 and therefore also within the entire pressure side, left hand side, of cavity 310. When the pressure is sufficiently great in magnitude, teeth 318 are not able to move any more fluid into the pressure port, since hydraulic fluid is a generally non-compressible fluid.

At a sufficiently high pressure, the resistance provided by the fluid within the pressure side of the cavity prevents the rotation of the ring gear of planetary gear set 100, by exerting a resistive force against teeth 318. Thence, when the rotation of the ring gear is mitigated or stopped, the sun gear and alternator input shaft are overdriven at or near the maximum overdrive ratio.

As engine speed increases from idle, and as the rotational velocity of pulley “P” increases, valve 350 correspondingly permits an increasing volume of fluid flow therethrough. When fluid flow through valve 350 increases, the relative pressure within pressure port 330 decreases and the rate at which the ring gear of planetary gear set 100 rotates increases. Accordingly, the instantaneous rotational velocity differential and the real time overdrive ratio decrease as engine speed increases, until the minimum overdrive ratio is achieved.

In yet other fluid-modulated embodiments, overdrive modulating assembly 40 includes, houses, and contains an electrorheological fluid, which stiffens into a semi-solid when subjected to an electric field; thus, electrorheological fluids change phase from liquid to gel-like, referred to by some as the Winslow effect. Typical electrorheological fluids include a particle suspension which has a large dielectric constant mismatch between the suspended particles and the fluid in which they are dispersed. Such devices also necessarily include e.g. various conductors in electric communication with, for example, an electrical power source, and/or other suitable components which are in combination adapted and configured to apply a variable strength electric field to the electrorheological fluid.

In such embodiments, the strength of the electric field is increased as the rotational velocity of planet carrier 138 increases. As the strength of the electric field increases, the electrorheological fluid stiffens. As the electrorheological fluid stiffens, planet gears 130 resist rotation. When the planet gears 130 resist rotation, relatively more torque is transmitted from planet carrier 138 to ring gear 110 and sun gear 120.

When the electric field is sufficiently strong, the electrorheological fluid is stiff enough to prevent planet gears 130 from rotating. At this point, the over drive assembly is locked-up whereby ring gear 110, sun gear 120, and planet carrier 138 rotate in rotational unison with each other. Thus, pulley “P” and alternator input shaft 30 rotate at the same rate of angular rotation.

Referring now to FIGS. 3A, 3B, 4A, 4B, 5A, 5B, 6A, 6B, 7A, and 7B, in other embodiments, the modulation devices include, for example, modulating by way of various mechanical or electromechanical devices, including, but not limited to, mechanically or electromagnetically actuated frictional or other engagement members, for example and without limitation clutches, brakes, and/or others. Exemplary of such are modulation devices “M” and “M2”.

Referring specifically to FIGS. 3A and 3B, and wherein carrier 138 is driven by pulley “P”, modulation device “M” provides a modulating frictional drag force to ring gear 110. In some embodiments, modulation device “M” is an electromechanical brake. At relatively low engine speeds, modulation device “M” holds ring gear 110 static or nearly static. As engine speed increases, modulation device “M” gradually releases its frictional drag force, corresponding to the increase in engine speed. Thus, as engine speed increases, modulation device “M” reduces its drag force and enables ring gear 110 to slip. At sufficiently high engine speed, the drag force applied by modulation device “M” is nominal or completely withdrawn which allows ring gear 110, sun gear 130, and planet carrier 138 to nominally or actually lock into rotational unison with each other.

In some embodiments, modulation device “M” is a static, e.g. optionally spring or otherwise resiliently biased member, which provides a generally constant drag force or frictional engagement on the outer circumferential surface of ring gear 110. As one example, when such embodiments of modulation devices “M” are used in combination with e.g. fluid coupling mechanisms to modulate overdrive modulating assembly 40, ring gear 110 overcomes at least in part the holding force of modulation device “M” when the magnitude of the fluid coupling force is greater than the sum of the magnitudes of the static inertia force of ring gear 110 and the drag force of modulation device “M”.

Referring now to FIGS. 4A, 4B, 6A, 6B, 7A, and 7B, in some embodiments, either (i) no fluid coupling device is utilized, or (ii) the fluid coupling device does not provide sufficient coupling force to modulate the overdrive modulating assembly 40, and thus cannot lock the overdrive modulating assembly 40 such that its components rotate in rotational unison. Further, either no frictional drag device “M” is used or the frictional drag device does not provide sufficient coupling force to completely modulate the overdrive modulating assembly as desired. In such embodiments, overdrive modulating assembly 40 can include, in addition or in the alternative, an electromagnetic modulation device “M2” which is adapted and configured to magnetically bias one or more components of overdrive modulating assembly 40.

Referring specifically to FIGS. 4A and 4B, modulation device “M2” is shown positioned between pulley “P” and alternator body 20. When modulation device “M2” is energized, it magnetically biases, for example, planet gears 130 axially toward alternator body 20. When planet gears 130 are magnetically biased, they slide axially along pinions 200, toward the source of magnetic flux i.e. modulation device “M2”.

Namely, when modulation device “M2” is energized, the magnetic force urges or draws the planet gears 130 axially along their respective pinions 200 and into face to face communication with the inner surface of the planet carrier 138, i.e. flange 150.

In other words, to modulate overdrive modulating assembly 40, modulation device “M2” is energized which magnetically biases planet gears 130 toward planet carrier 138, whereby a frictional drag force is realized between the side surfaces of the planet gears and the side surface of the planet carrier. Thus, the planet gears also serve as frictional engagement, drag creating, or braking elements. The strength of the magnetic field determines, at least in part, the biasing force imparted upon the planet gears 130. As engine speed increases, the magnitude of the magnetic force generated by modulation device “M2” correspondingly increases.

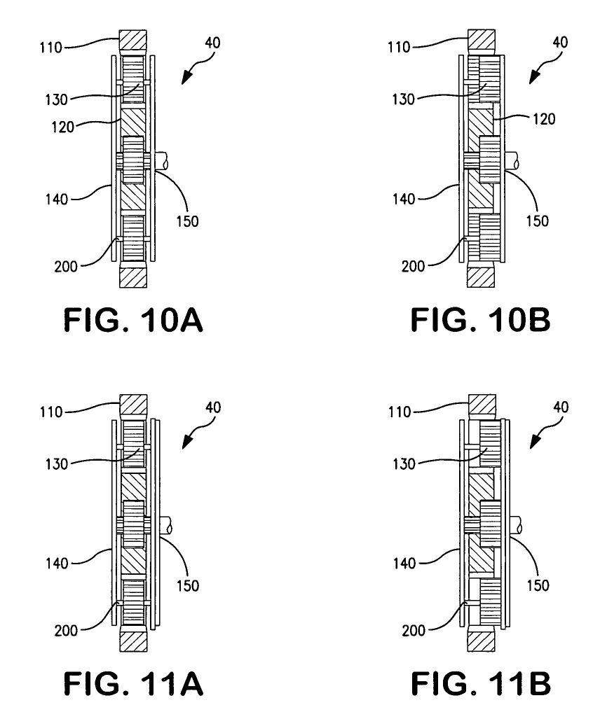

At sufficiently high engine speed, the magnetic force is increased sufficiently, and the planet gears 130 are urged into the inwardly facing surface of flange 150 with a force sufficiently great, to prevent planet gears 130 from rotating about the respective pinions 200. In this fully gear biased state, the overdrive modulating assembly is locked-up, whereby all components of overdrive modulating assembly 40 rotate in rotational unison with each other. FIG. 10A shows overdrive modulating assembly 40 with the planet gears in a first, unbiased, position. FIG. 10B shows overdrive modulating assembly 40 with modulation device “M2” energized (not shown), whereby planet gears 130 are in a second, biased position and interface with flange 150.

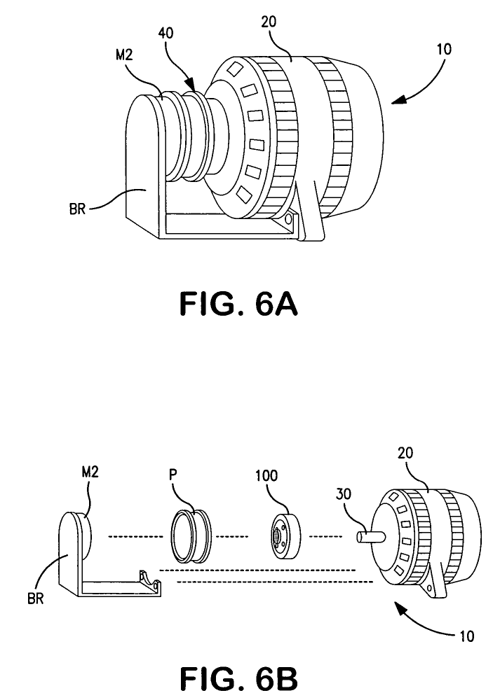

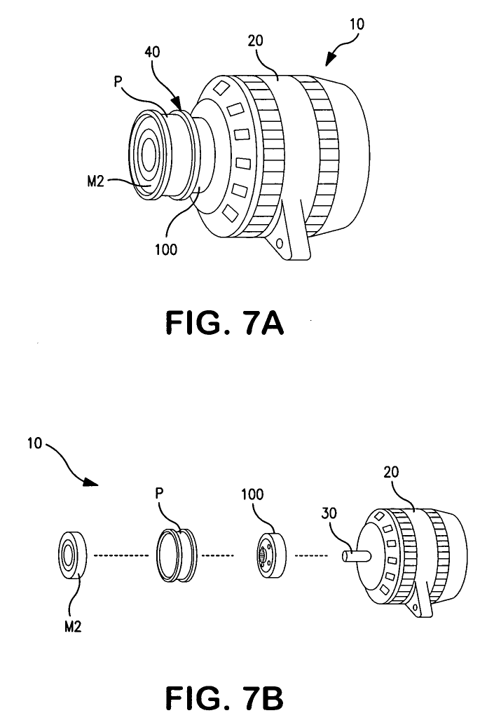

Referring now to FIGS. 6A, 6B, 7A, and 7B, as desired, modulation device “M2” can be mounted distal alternator body 20, whereby overdrive modulating assembly 40 lies between the modulation device “M2” and alternator body 20. Such a configuration is particularly beneficial when using a relatively powerful electromagnet as modulation device “M2”, which could interfere with operation of the alternator.

In some embodiments, modulation device “M2” is mounted to an external support structure, such as bracket “BR”. Bracket “BR” is attached to alternator body 20 in FIGS. 6A and 6B, but it is fully comprehended that an external support device can be mounted in any suitable location within the engine compartment, provided that the end-use orientation of modulation device “M2” accommodates suitable operation of modulation assembly 40. In some embodiments, such as those of FIGS. 7A and 7B, modulation device “M2” is concentrically housed within pulley “P”, which eliminates the need for external support structure such as bracket “BR”.

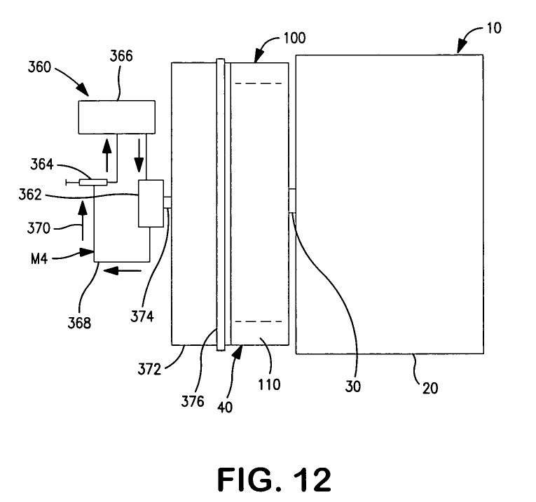

FIG. 12 shows another externally modulated overdrive modulating alternator assembly 10. Alternator assembly 10 includes an alternator 20 receiving power through shaft 30 from a sun gear of a modulated planetary gear assembly 100. Power is received from an engine at the planet gear carrier, and is modulated by manipulation of ring gear 110. Ring gear 110 is manipulated by an external hydraulic pump circuit 360. Hydraulic pump circuit 360 functions as an external modulator and includes a positive displacement hydraulic pump 362, a needle valve 364, and a hydraulic fluid reservoir 366. Piping 368 connects pump 362, valve 364, and reservoir 366 to each other. Hydraulic fluid is pumped through circuit 360 in the direction shown by arrows 370.

Housing 372 extends axially from an outer portion of ring gear 110, and turns with ring gear 110. Drive shaft 374 extends from pump 362 and connects to housing 372 such that pump 362 rotates at the same angular speed as ring gear 110, whereby rotation of ring gear 110 drives pump 362.

Brake band 376 is mounted to housing 372 and is further mounted to a stationary support (not shown).

At start up of the driving engine, brake band 376 is locked and needle valve 364 is fully closed. The combined efforts of the needle valve and the brake band assure that the modulating ring gear does not rotate at low engine speeds, whereby the maximum overdrive ratio is passed on to alternator 20. The needle valve and brake band are held in these configurations at all low speeds of the engine. As the engine speed increases such that alternator 20 is producing maximum power output, such as at 3000-4000 rpm, the brake band is released which reduces the resistance to rotation of ring gear 110. While the needle valve typically remains closed as the brake band is released, the force on the ring gear at such engine speeds applies sufficient energy to the ring gear that some leakage of hydraulic fluid may occur at needle valve 364, whereupon the ring gear begins to rotate, albeit under substantial resistance from the hydraulic circuit, providing initial modulation of the overdrive ratio. As engine speed increases further, needle valve 364 is progressively opened whereby the driving force on hydraulic pump begins to pump hydraulic fluid through the hydraulic circuit, thus modulating the rotation of ring gear, and thus providing further modulation of the overdrive ratio between the planet carrier and the sun gear.

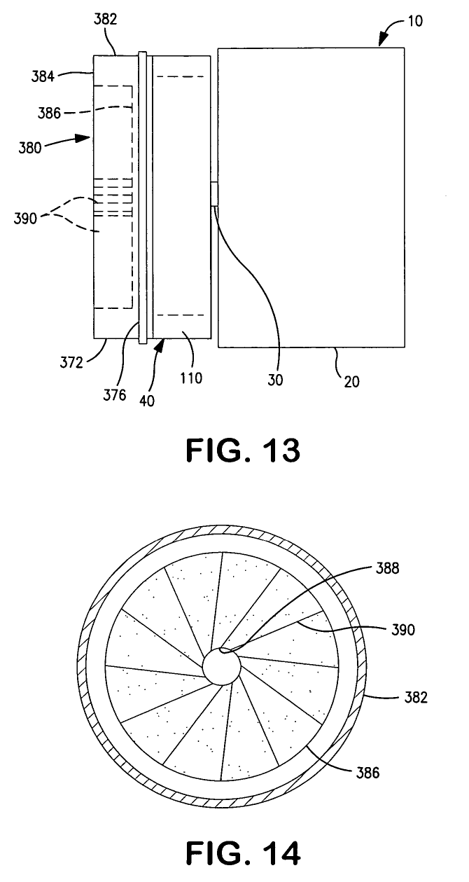

FIGS. 13 and 14 show an internally modulated overdrive modulating alternator assembly 10. Alternator assembly 10 includes an alternator 20 receiving power through shaft 30 from a sun gear of a modulated planetary gear assembly 100. Power is received from an engine at the planet gear carrier, and is modulated by manipulation of ring gear 110. Ring gear 110 is manipulated by an internal hydraulic pump 380. Generally cylindrical ring gear housing 372 extends axially outwardly from ring gear 110. Ring gear housing 372 includes a cylindrical side wall 382 and an end wall 384. Pump 380 includes a baffle 386 extending parallel to end wall 384. Baffle 386 is spaced from cylindrical side wall 382 and has a central opening 388. A plurality of pumping blades 390 extend between, and are mounted to, both baffle 386 and end wall 384. Brake band 376 is mounted to housing 372 and is further mounted to a stationary support (not shown).

At start up of the driving engine, and at low engine speeds, brake band 376 is locked, preventing the ring gear from turning, whereby maximum overdrive is passed on to the alternator through the sun gear. As the engine gains speed such that the alternator is turning at a desired speed which produces maximum electrical power, the brake band is released, enabling the initiation of rotation of the ring gear. As the ring gear rotates, hydraulic fluid inside housing 372 is pumped, by blades 390 through central opening 388 and centrifugally outwardly to the outer edge of baffle 386 and cylindrical side wall 382 of the housing, thus establishing a hydraulic pumping circuit inside housing 372. As the speed of the ring gear increases, the rate at which hydraulic fluid is pumped through the circuit increases, thus providing for faster rotation of the ring gear and reduction of the overdrive ratio. By properly sizing the elements of the hydraulic pumping circuit, the hydraulic circuit can become self-regulating such that rotation of the ring gear is sufficient to provide over-speeding of the alternator at high engine speeds.

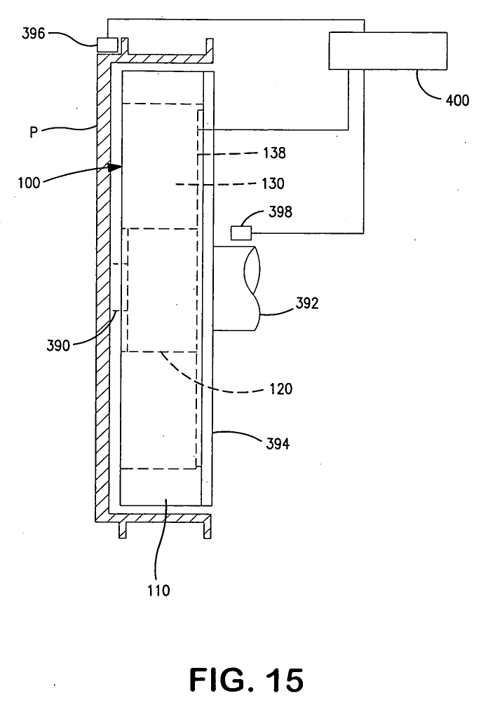

FIG. 15 shows an elevation view, partially in cross-section, of an underdrive power converting modulator of the invention. The power converting modulator of FIG. 15 is structured to underdrive the output angular shaft speed relative to the input angular speed received into the modulator assembly. Pulley “P” is shown in cross-section. A drive shaft 390 extends from pulley “P” to sun gear 120 as the input shaft which receives power from the internal combustion engine. An output shaft 392 is connected to an end plate 394 which is mounted to, and rotates with ring gear 110 as the output component of the planetary gear assembly 100. The output of the planetary gear assembly is modulated through carrier 138. Sensor 396 senses speed of rotation of input pulley “P”. Sensor 398 senses speed of rotation of output shaft 392. Sensors 396 and 398 communicate data to computer 400. Computer 400 analyzes the data received from sensors 396 and 398 and sends modulation commands to an actuator which controls the speed of rotation of carrier 138.

At low engine speeds, carrier 138 is held stationary whereby the full underdrive ratio, e.g. ¼ to ⅙ of engine speed, is passed on to output shaft 392, such that the load which is being driven by output shaft is driven at the respective underdrive speed, less than the angular rotation speed of input pulley “P”. The result of such underdriving is that the load sensed by the engine is substantially less than a direct drive load driven directly from pulley “P”. Thus, for example, if pulley speed is 700 rpm, a direct drive speed would be 700 rpm whereas a ¼ underdrive speed is 175 rpm. Accordingly, the purpose of the underdrive modulation is to initially drive the load at a reduced speed, thus placing less of a load on the engine when the engine is producing a relatively low power output.

As engine speed is accelerated to maximum speed through advance of the throttle, the underdrive load ratio is maintained through commands sent by computer 400 to the carrier actuator until such time as the engine speed reaches a pre-set speed where the engine is producing power at or near its rated capacity. Once engine speed increases to near the rated operating speed of the engine, computer 400 sends commands which gradually reduce the underdrive ratio, thus applying increasing loads to on the engine, at rates which aggressively accelerate the load while maintaining a sufficiently high engine speed that the engine continues to produce power at or proximate its rated capacity.

By so reducing the load on the engine as the engine speed accelerates, the engine is enabled to reach rated speed and rated power output much more quickly, whereby the higher level of power output can then be applied to the load, resulting in an overall faster acceleration of the load once throttle power is applied to the engine.

While an underdrive load has been illustrated in FIG. 15 as having a pulley-based input to the sun gear, the input from the engine can as well be a direct drive shaft, coming in-line directly from the engine crankshaft or a gearbox slaved to the engine crankshaft, as desired, whereby no pulley is needed. In such event, the output of the engine crankshaft can be fed directly to the sun gear.

Similarly, while FIG. 15 illustrates the power being taken off the planetary gear assembly at ring gear 110 and carrier 138 used as the modulator, the structure can as well be reversed such that the power is taken off the planetary gear and fed to the load through planet carrier 138 whereby ring gear 110 is used as the modulator.

Although not required, clutch or friction material can be placed between the component which is being modulated and a second portion of the modulation assembly against which it is moving. Thus friction can be placed between planet gears 130 and the planet carrier, e.g. on the inwardly facing surface of one or more of the planet carrier end flanges, such as in the embodiments illustrated in FIGS. 11A and 11B. Although the clutch or friction material is illustrated on the planet carrier end flanges, such material can be installed on, for example, the alignment plates, the planet gears, or elsewhere, as desired. Such clutch or friction material can function, for example, to improve the modulating efficiency of the system or to possibly extend the use life by mitigating the amount of metal-to-metal interface and corresponding grooving or other wear of the relevant components.

To use overdrive modulating alternator 10, the user merely operates the vehicle or other internal combustion engine powered device in the typical manner. This is possible because overdrive modulating alternator 10 outputs a generally constant current, proximate the optimum current output value, throughout the entire engine operating speed range i.e. between idle and wide open throttle, without requiring any user input; so long as the overdrive ratio V3/V1 is sufficiently great that the overdriven alternator speed at engine idle speed is in the relatively flat portion of the current output curve such as is illustrated in FIG. 1B.

Referring to the use of a device which inputs torque through carrier 138 and modulates ring gear 110, during operation, driving torque from pulley “P” is transmitted through planet carrier 138, through planet gears 130, and to sun gear 120, thus rotating it.

At engine idle, ring gear 110 is heavily modulated, optionally held static. Depending on the particular configuration of overdrive modulating assembly 40, ring gear 110 rotation is modulated and mitigated by e.g. its own resting state inertia, and/or by modulation device “M,” “M2,” “M3,” by a brake band, or otherwise. Accordingly, with ring gear 110 rotation mitigated at idle, overdrive modulating alternator 10 is operating at its highest overdrive ratio, whereby the instantaneous rotational velocity differential between velocities “V3” and “V1”, namely the ratio V3/V1, is at its maximum value and the alternator current output is at or proximate its rated maximum output value.

As the user introduces a throttle input, the internal combustion engine speed increases which drives the belt and pulley “P” and carrier 138 relatively faster. Simultaneously, either (i) the modulating force is held constant and the increased momentum from increased carrier 138 rotational velocity urges ring gear 110 to increase its rotational velocity, and/or (ii) the modulating force is reduced whereby the ring gear 110 increases its rotational velocity.

Either way, as ring gear 110 slips the modulating force, rotational velocity of the ring gear increases, hence the overdrive ratio correspondingly decreases and the instantaneous rotational velocity ratio V3/V1 likewise decreases. Such real time decrease in instantaneous rotational velocity differential maintains the alternator current output at or proximate its rated maximum output value.

As the user continues to increase throttle input, engine speed continues to increase, as do the rotational velocities of the pulley “P” and carrier 138. Correspondingly, the real time overdrive ratio and the instantaneous rotational velocity ratio V3/V1 continues to decrease, smoothly and gradually with respect to engine speed increase and without any sudden or clutched step changes in the V3/V1 ratio.

When the user provides a wide open throttle condition, engine speed achieves a maximum value, as do the rotational velocities of the pulley “P” and carrier 138 whereupon the real time overdrive ratio V3/V1 and the instantaneous rotational velocity differential between velocities “V1” and “V3” reach their respective minimum values.

Referring to the use of a device which inputs torque through ring gear 110 and modulates carrier 138, during operation, driving torque from pulley “P” is transmitted through ring gear 110, through planet gears 130, and to sun gear 120, thus rotating sun gear 120.

At engine idle, planet carrier 138 is heavily modulated, optionally held static. Depending on the particular configuration of overdrive modulating assembly 40, carrier 138 rotation is modulated and mitigated by e.g. its own resting state inertia, and/or by a modulation device “M,” “M2,” “M3,” a brake band, or otherwise. Accordingly, with carrier 138 rotation mitigated at idle, overdrive modulating alternator 10 is operating at its highest overdrive ratio V3/V1, whereby the instantaneous rotational velocity differential between velocities “V3” and “V1” is at its maximum value and the alternator electrical current output is at or proximate its rated maximum output value.

As the user introduces a throttle input, engine speed increases which drives the drive belt, pulley “P”, and ring gear 110 relatively faster. Simultaneously, either (i) the modulating force is held constant and the increased momentum from increased ring gear 110 rotational velocity urges carrier 138 to increase its rotational velocity, and/or (ii) the modulating force is reduced whereby carrier 138 increases its rotational velocity.

Either way, as carrier 138 slips in accord with the reduced modulating force, rotational velocity of the carrier increases, hence the overdrive ratio V3/V1 correspondingly decreases and the instantaneous rotational velocity differential between velocities “V3” and “V1” likewise decreases. Such real time decrease in instantaneous rotational velocity differential enables the alternator current output to be maintained at or proximate its rated maximum output value.

As the user continues to increase throttle input, the engine speed continues to increase, as do the rotational velocities of the pulley “P” and ring gear 110. Correspondingly, the real time overdrive ratio V3/V1 and the instantaneous rotational velocity differential between velocities “V3” and “V1” continue to decrease, smoothly, continuously with respect to engine speed increase.

When the user produces a wide open throttle condition, the engine speed achieves a maximum value, as do the rotational velocities of the pulley “P” and ring gear 110, while the real time overdrive ratio V3/V1 and the instantaneous rotational velocity differential between velocities “V3” and “V1” can potentially express their respective minimum values.

However, since the sun gear is driven in the opposite direction from the ring gear at full modulation, and since the sun gear must rotate in the same direction as the ring gear at lock-up, at some point in the modulation of the carrier, there is the potential for the alternator to actually stop rotating. Since rotation of the sun gear is always desired, the modulation of the carrier is controlled such that the sun gear is always rotating opposite in direction to the ring gear, and at a speed which ensures a desired amount of output from the driven alternator. Thus, where the ring gear is the input element, the drive ratio never reaches 1/1 because the carrier always modulates the drive in order to maintain suitable power output from the alternator.

The above description has focused on use of planetary gear assemblies in overdrive modulating of vehicle alternators, and especially alternators used in small and medium-size marine craft, for example marine craft which vary the speeds of the engines substantially during marine operations. Exemplary of such watercraft, but not limited to same, are pleasure boats in the range 12 feet length to about 60 feet length.

In view of the above discussion, the inventor herein contemplates that there are a number of other uses for such overdrive modulating devices in driving other power-consuming devices related both to vehicular implementations and non-vehicular implementations. One such use is to employ a planetary gear assembly to modulate the drive speed of a mechanical drive train which is used to power the travel velocity of a vehicle. Namely, modulation of a planetary gear assembly is used to provide a continuously-variable drive ratio between the engine speed and the driven speed of the drive train, which might be considered as a proxy for a continuously-variable transmission.

In such use, the pulley “P” is connected to sun gear 120 as the power input component. The power output component which transmits drive power to the drive train is ring gear 110. Carrier 138 is used to modulate the speed of the drive train as driven by ring gear 110.

In operation, the carrier is fully locked up so as to actuate the maximum underdrive ratio of the planetary gear assembly. Thus, where the underdrive ratio is e.g. about ¼ to about ⅙, the drive speed on the drive train is only ¼ to ⅙ as great as the lock-up speed where the speed of the drive train is slaved to the speed of the engine. With such a lower drive speed on the drive train, the engine speed can quickly accelerate to an engine speed where maximum power is being developed by the engine.

Sensors on the ring gear or pulley, and on the sun gear or input shaft on the drive train, feed rotational speed data as proxies for ring gear speed and sun gear speed to the controlling computer. The computer sends modulation commands to a modulator which controls carrier 138 thus to modulate the carrier so as to feed a continuously increasing load to the engine, thus increasing speed of the drive train, while maintaining the engine speed at a rotational magnitude which produces a high level of drive power, such as the maximum power which the engine can produce.

As the load speed increases, the underdrive ratio increases toward 1/1 such that the difference between speed of the sun gear and the ring gear is increasingly less, while the rotational speed of the carrier increases. As the power of the engine approaches picking up the full potential load, the rotational speeds of the sun gear, the ring gear, and the carrier approach a common speed, whereupon the underdrive ratio approaches, and can reach, 1/1. As the underdrive ratio reaches 1/1, the modulator assembly 40 can be locked up in a manner similar to that discussed earlier with respect to the overdrive embodiments. As modulator assembly 40 is locked up, pulley speed matches ring gear speed, matches drive train speed, whereupon a normal direct drive environment speed has been achieved.

Thus, the modulation discussed here for driving a drive train is a temporary modulation of the coupling of the engine to the drive train. Once the load speed has caught up to the engine speed, the modulating assembly can be locked up for conventional transmission of power from the engine to the drive train.

Any time the user applies less than full throttle, the computer can sense the relative load being applied to the engine, can correlate that to the capability of the engine to produce a desired amount of power and, if and as desired can decouple the engine from the direct drive situation by again sending modulation commands to carrier 138.

By thus modulating the load while maintaining e.g. maximum engine power output, the drive speed of the e.g. boat can be accelerated under maximum power output of the engine; without having to accelerate the boat at the same time the engine is accelerating to its maximum power output. Such modulation can be applied from an idle condition, or from a partial throttle condition when a greater level of power is applied at the throttle.

By thus feeding maximum engine power output to the drive train for substantially the entirety of the period during which the watercraft is accelerating its across-the-water speed, acceleration time for the watercraft is substantially reduced. Further, by so using the maximum power available at the time when the watercraft needs the most power, the user has the option of either
(a) achieving a higher rate of acceleration with the same engine, or
(b) purchasing a lower rated, less costly, more fuel efficient, engine while achieving the same rate of watercraft across-the-water acceleration.

Accordingly, the invention contemplates a drive train which includes a driven assembly, and a such modulated planetary gear assembly connected to the driven assembly, and wherein the driven assembly receives its drive input from the modulated planetary gear assembly. Such drive train can be connected to an internal combustion engine selected by the user. The planetary gear assembly can be modulated by any effective modulation structure and control which effectively feeds the load to the engine at a rate which does not cause an excessive reduction of engine speed so as to lose the benefit of feeding the load at speeds beneficial to engine power output.

While the invention has been described herein with respect to driving watercraft, such modulation assemblies can as well be applied to land-based vehicles as well as aircraft. Further, the principle of modulating the load using a planetary gear assembly can be applied to stationary implementations of internal combustion engines. Accordingly, the invention is not limited to watercraft implementations, nor strictly to vehicular implementations. Rather, the invention can be applied anywhere a load is connected to, driven by, an internal combustion engine.

Modulating assembly 40 can be made as individual components, with such components assembled into sub-assemblies. The sub-assemblies are then assembled with each other to arrive at the complete assemblage of modulating assembly 40.

Preferably, modulating assembly 40 is made of materials which resist corrosion, and are suitably strong and durable for normal extended use. Those skilled in the art are well aware of certain metallic and non-metallic materials which possess such desirable qualities, and appropriate methods of forming such materials.

Appropriate metallic materials for various components of the modulating assembly 40 include, but are not limited to, aluminum, steel, stainless steel, titanium, magnesium, brass, and their respective alloys, as well as other metallic materials. Common industry methods of forming such metallic materials include casting, forging, shearing, bending, machining, riveting, welding, powdered metal processing, extruding, and others.

Non-metallic materials suitable for components of overdrive modulating alternator 10, e.g. seals, bushings, and/or others, are various polymeric compounds, such as for example and without limitation, various of the polyolefins and various of the rubbers and rubber-like synthetic materials.

As used herein, “overdrive ratio” is a ratio equal to or greater than 1/1, and is calculated as
overdrive ratio=output angular speed of sun gear 120/input angular speed of pulley “P”.

As used herein, “underdrive ratio” is a ratio equal to or less than 1/1, and is calculated as
underdrive ratio=output angular speed of sun gear 120/input angular speed of pulley “P”.

As used herein, “modulated” means to pass gradually from one state to another, without intermittent step changes in state in the process.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. An underdriving or overdriving power converting modulator assembly adapted and configured to be driven by an internal combustion engine, said power converting modulator assembly, comprising:
(a) a planetary gear assembly having an input component, an output component, and a modulated component, said planetary gear assembly comprising
(i) a ring gear,
(ii) a sun gear axially aligned with said ring gear and disposed concentrically inwardly of said ring gear,
(iii) a plurality of planet gears engaging both said ring gear and said sun gear, and
(iv) a planet carrier confining said planet gears between said ring gear and said sun gear; and
(b) a modulator communicating with one of said ring gear, said sun gear, and said planet carrier, and modulating an input/output ratio of the others of said ring gear, said sun gear, and said planet carrier.

2. A power converting modulator assembly as in claim 1, further comprising a load which is to be driven by said power converting modulator assembly, said load being drivingly connected to one of said sun gear and said planet carrier as said output component of said planetary gear assembly.

3. A power converting modulator assembly as in claim 2 wherein said power converting modulator assembly is an overdriving modulator assembly and wherein said load comprises an alternator.

4. A power converting modulator assembly as in claim 1 wherein said modulator is selected from the group consisting of mechanical brakes, hydraulic circuits, and electromagnetically actuated modulators.

5. A power converting modulator assembly as in claim 1 wherein said modulator modulates one of said ring gear and said planet carrier.

6. A power converting modulator assembly as in claim 1 wherein said input component comprises said planet carrier and said output component comprises said sun gear.

7. A power converting modulator assembly as in claim 1 wherein said input component comprises said ring gear and said output component comprises said sun gear.

8. A power converting modulator assembly as in claim 1 wherein said power converting modulator assembly is an underdriving assembly.

9. A power converting modulator assembly as in claim 8 wherein said input component comprises said sun gear and said output component comprises said ring gear.

10. A power converting modulator assembly as in claim 8 wherein said input component comprises said sun gear and said output component comprises said planet carrier.

11. A power converting modulator assembly as in claim 8, further comprising a load which is to be driven by said power converting modulator assembly, said load being drivingly connected to one of said ring gear and said planet carrier as said output component of said planetary gear assembly.

12. A power converting modulator assembly as in claim 11 wherein said load comprises a vehicular drive train in a vehicle, and wherein said vehicular drive train is adapted and configured to move said vehicle.

13. A power converting modulator assembly as in claim 1 wherein said modulator modulates the input/output ratio such that such input/output ratio at least approaches 1/1 as such engine approaches maximum rated speed.

14. A power converting modulator assembly as in claim 1, further comprising a computer controller controlling the modulation of said one of said ring gear, said sun gear, and said planet carrier by said modulator.

15. In combination, an alternator and an alternator drive assembly, adapted to be driven by an internal combustion engine, said alternator and alternator drive assembly comprising:
(a) an alternator having a stator, a rotor, and a drive shaft; and
(b) a modulated overdriving alternator drive assembly connected to said drive shaft of said alternator, said modulated overdriving alternator drive assembly comprising
(i) a planetary gear assembly having an input component, an output component, and a modulated component, said planetary gear assembly comprising
A. a ring gear,
B. a sun gear,
C. a plurality of planet gears engaging both said ring gear and said sun gear, and
D. a planet carrier confining said planet gears between said ring gear and said sun gear, and
(ii) a modulator communicating with, and modulating, one of said ring gear, said sun gear, and said planet carrier, and thereby modulating an output/input ratio of the others of said ring gear, said sun gear, and said planet carrier.

16. A combination as in claim 15 wherein said modulated planetary overdriving alternator drive assembly has a maximum overdriving output/input ratio of about 3/1 to about 8/1.

17. A combination as in claim 15 wherein said modulator modulates the overdriving output/input ratio such that such overdriving ratio at least approaches 1/1 as such engine approaches maximum rated speed.

18. A combination as in claim 15 wherein said drive shaft of said alternator is drivingly engaged with said sun gear.

19. A combination as in claim 15 wherein said modulator communicates with, and modulates, one of said planet carrier and said ring gear.

20. A combination as in claim 15 wherein said modulator is selected from the group consisting of mechanical brakes, hydraulic circuits, and electromagnetically actuated actuators.

21. A combination as in claim 15 wherein said input component comprises said planet carrier and said output component comprises said sun gear.

22. A combination as in claim 15, further comprising a computer controller controlling the modulation of said one of said ring gear, said sun gear, and said planet carrier by said modulator.

23. A method of driving a load using an internal combustion engine as a driving power source, the method comprising driving the load through a modulated underdrive mechanism having a minimum underdrive output speed/input speed ratio, and a maximum underdrive output speed/input speed ratio of up to about 1/1, the underdrive mechanism being driven by an output of the engine, and the load being driven by an output of the modulated underdrive mechanism, the method comprising:
(a) when operating the engine in a strong acceleration mode to a higher engine speed, modulating the underdrive mechanism so as to avoid transfer of full potential load to the engine during such strong acceleration; and
(b) after the engine has reached the higher engine speed, demodulating the underdrive mechanism at a continuously increasing drive ratio so as to smoothly apply full potential load to the engine while maintaining engine speed at or near the higher engine speed.

24. A method as in claim 23, further comprising operating the underdrive modulating mechanism as substantially a direct drive when the engine is not in a strong acceleration mode.

25. A method as in claim 23, further comprising modulating the output of the engine using a modulated underdrive mechanism which comprises a planetary gear assembly and a modulator, the planetary gear assembly having an input component, an output component, and a modulated component, and wherein the planetary gear assembly comprises
(i) a ring gear,
(ii) a sun gear,
(iii) a plurality of planet gears engaging both the ring gear and the sun gear, and
(iv) a planet carrier confining the planet gears between the ring gear and the sun gear,
and wherein the modulator modulates one of the ring gear and the planet carrier.

26. A method as in claim 23 wherein the load comprises a vehicle drive train driving a vehicle.

27. A method as in claim 23 wherein the modulator is selected from the group consisting of mechanical brakes, hydraulic circuits, and electromagnetically actuated modulators.

28. A method as in claim 25 wherein the method comprises inputting drive power from the engine into the modulated underdrive mechanism at the sun gear, and transferring drive power from the modulated underdrive mechanism to the load at one of the ring gear and the planet carrier.

29. A method as in claim 23, further comprising sensing angular input speed into the modulator and angular output speed out of the modulator, feeding the sensed input and output speeds to a computer controller, and outputting modulation commands from the computer controller to the modulator, thereby to control the modulation of the output speed/input speed ratio.
